(19) United States
(12) Patent Application Publication
(10) Pub. No.: US 2019/0144753 A1
(43) Pub. Date: May 16, 2019

(54) LIQUID CRYSTAL DISPLAY DEVICE, AND METHOD FOR PRODUCING LIQUID CRYSTAL DISPLAY DEVICE

(71) Applicant: SHARP KABUSHIKI KAISHA, Sakai City, Osaka (JP)

(72) Inventors: MASANOBU MIZUSAKI, Sakai City (JP); HIROSHI TSUCHIYA, Sakai City (JP); KIYOSHI MINOURA, Sakai City (JP)

(21) Appl. No.: 16/314,591

(22) PCT Filed: Jul. 3, 2017
(86) PCT No.: PCT/JP2017/024303

§ 371 Date: Dec. 31, 2018

(30) Foreign Application Priority Data
Jul. 4, 2016 (JP) 2016-132540

(51) Int. Cl. C09K 19/56; G02F 1/1337; C09K 19/30; G02F 1/1339; C09K 19/04

(52) U.S. Cl. CPC C09K 19/56; G02F 1/133788; C09K 19/3003; G02F 1/1339; C09K 2019/3004; C09K 2019/301; G02F 2001/133738; C09K 2019/0444; G02F 1/133711

(57) ABSTRACT

A liquid crystal display device includes: a liquid crystal layer containing a liquid crystal material; a sealing member disposed to surround the liquid crystal layer in a plan view; a pair of substrates that are bonded to each other by the sealing member, and sandwich the liquid crystal layer; and an alignment control layer disposed to be in contact with the liquid crystal layer in a region surrounded by the sealing member in a plan view, the alignment control layer aligning the liquid crystal material in a direction horizontal to faces of the substrates, and containing a polymer containing at least a unit derived from a specific first monomer.

### TECHNICAL FIELD

The present invention relates to a liquid crystal display device, and a method for producing a liquid crystal display device. More specifically, the present invention relates to a liquid crystal display device having an alignment control layer, and a method for producing a liquid crystal display device.

### BACKGROUND ART

A liquid crystal display device is a display device utilizing a liquid crystal composition for display, and in a typical display method for liquid crystal display devices, a liquid crystal panel in which a liquid crystal composition is enclosed between a pair of substrates is irradiated with light from a backlight, and a voltage is applied to the liquid crystal composition to change the alignment of the liquid crystal material, and thus the amount of light transmitting through the liquid crystal panel is controlled. Liquid crystal display devices as described above have advantages of low profile, light weight and low power consumption, so that they are used in electronic devices such as a smartphone, a tablet PC, and a car navigation system.

As another display method for liquid crystal display device, a transverse electric field display mode receives attention, for example, for ease of obtaining the wide viewing angle characteristic. In the transverse electric field display mode, control is performed by rotating the alignment of the liquid crystal material mainly in a plane parallel with faces of substrates. Examples of the transverse electric field display mode include an in-plane switching (IPS) mode, and a fringe field switching (FFS) mode.

In a liquid crystal display device, the alignment of the liquid crystal material in the condition that a voltage is not applied is generally controlled by an alignment film having undergone an alignment treatment. The alignment film is prepared, for example, by applying an alignment film material such as polyamic acid or the like on a substrate, followed by baking. As another method for controlling alignment of a liquid crystal material, a polymer sustained alignment technique (hereinafter, also referred to PSA technique) in which a polymerizable monomer added into the liquid crystal layer is polymerized to form a polymer layer that controls alignment of the liquid crystal material on a face of the alignment film has been investigated (see, for example, Patent Literatures 1 to 3). Further, controlling alignment of a liquid crystal material by the polymer layer without forming a conventional alignment film has also been investigated (see, for example, Patent Literatures 1 and 2).

### CITATION LIST

### Patent Literature

Patent Literature 1: JP 2015-205982 A
Patent Literature 2: JP 2010-033093 A
Patent Literature 3: US 2012/0021141 A1

### SUMMARY OF INVENTION

### Technical Problem

Recently, a liquid crystal display device tends to have a broader display area, and this requires narrowing the frame area. A display area means an area where an image recognized by an observer is displayed, and does not include a frame area. In the frame area, for example, a gate driver, a source driver, and a display control circuit are accommodated. As one method for narrowing the frame area, narrowing the area of the sealing member for pasting a pair of substrates together has been examined, however, narrowing the width of the sealing member can deteriorate the peel strength between the substrates and cause peeling.

In the conventional PSA technique, the liquid crystal material or the like can decompose by light irradiation depending on the type of the polymerizable monomer added to the liquid crystal layer, or the type of the irradiated light, and this can deteriorate the voltage holding ratio (VHR).

In view of the above state of the art, it is an object of the present invention to provide a liquid crystal display device having high peel strength between substrates, and capable of keeping an excellent voltage holding ratio not only in a normal temperature environment, but also in a high temperature environment, and a method for producing a liquid crystal display device capable of producing such a liquid crystal display device.

### Solution to Problem

In order to respond to a narrowed frame of a liquid crystal display device, the present inventors investigated narrowing the width of the sealing member that pastes a pair of substrates together. The present inventors have found that a liquid crystal display device having a conventional alignment film is prone to peel at an interface between an alignment film and a sealing member. This is because substrates are pasted together by the sealing member to form the liquid crystal layer after alignment films are formed on faces of substrates, and the sealing member and each of the substrates are intervened by the alignment film, and the adhesive strength between the sealing member and the alignment film is poor.

The present inventors have found that by disposing an alignment control layer so as to be in contact with the liquid crystal layer in a region surrounded by the sealing member in a plan view in place of a conventional alignment film, it is possible to control alignment of the liquid crystal material without necessity of forming a conventional alignment film on a face of substrate. The present inventors have found that a sufficient peel strength can be obtained even when the width of the sealing member is narrowed because the pair of substrates can be bonded to each other in such a manner that each of the substrates is in contact with the sealing member while the substrate and the sealing member are not intervened by an alignment film.

On the other hand, in a liquid crystal display device not having a conventional alignment film on a face of substrate, the contrast ratio can decrease. Investigations by the present inventors have revealed that a pre-tilt angle is partially formed under the influence of irregularities of faces of substrates (for example, steps arising in the boundary between the region where an electrode is formed, and the region where an electrode is not formed), so that the contrast ratio decreases particularly when the liquid crystal material is aligned in the direction horizontal to faces of substrates. The present inventors also have found that by polymerizing a monomer added into a liquid crystal layer to form an alignment control layer, the influence of the irregularities of faces of substrates is significantly reduced, and formation of a partial pre-tilt angle is prevented, and a high contrast ratio can be obtained.

Further, the present inventors have found that by using a monomer containing a chalconyl group as a material for an alignment control layer that aligns a liquid crystal material in the direction horizontal to faces of substrates, it is possible to polymerize monomer with polarized ultraviolet rays, so that it is possible to form an alignment control layer with lower radiation intensity compared with irradiation with unpolarized light. The present inventors have conceived that by lowering the intensity of the light applied to the liquid crystal layer, decomposition of the liquid crystal material is less likely to occur, so that an excellent voltage holding ratio can be maintained not only in a normal temperature environment but also in a high-temperature environment, and accomplished the present invention.

One aspect of the present invention may be a liquid crystal display device including a liquid crystal layer containing a liquid crystal material, a sealing member disposed to surround the liquid crystal layer in a plan view, a pair of substrates that are bonded to each other by the sealing member, and sandwich the liquid crystal layer, and an alignment control layer disposed to be in contact with the liquid crystal layer in a region surrounded by the sealing member in a plan view, the alignment control layer aligning the liquid crystal material in a direction horizontal to faces of the substrates, and containing a polymer containing at least an unit derived from a first monomer represented by the following Chemical formula (A):

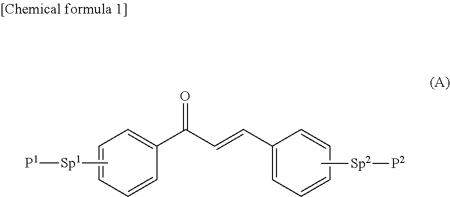

wherein P¹ and P² are the same as or different from each other, and each represent an acryloyloxy group, a methacryloyloxy group, an acryloylamino group, a methacryloylamino group, a vinyl group, or a vinyloxy group, and

Sp¹ and Sp² are the same as or different from each other, and each represent a linear, branched, or cyclic C1-C6 alkylene group, a linear, branched, or cyclic C1-C6 alkyleneoxy group, or a direct bond.

Another aspect of the present invention may be a method for producing a liquid crystal display device, including a step of sealing a liquid crystal composition containing a liquid crystal material and at least one type of monomer between a pair of substrates bonded to each other by a sealing member to form a liquid crystal layer, and a step of irradiating the liquid crystal layer with polarized ultraviolet rays to form an alignment control layer by polymerization of the at least one type of monomer at an interface between the pair of substrates and the liquid crystal layer, the at least one type of monomer containing a first monomer represented by the following Chemical formula (A), the alignment control layer aligning the liquid crystal material in a direction horizontal to faces of the substrates,

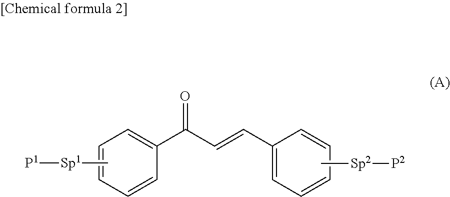

wherein P¹ and P² are the same as or different from each other, and each represent an acryloyloxy group, a methacryloyloxy group, an acryloylamino group, a methacryloylamino group, a vinyl group, or a vinyloxy group, and

Sp¹ and Sp² are the same as or different from each other, and each represent a linear, branched, or cyclic C1-C6 alkylene group, a linear, branched, or cyclic C1-C6 alkyleneoxy group, or a direct bond.

Patent Literature 1 discloses a liquid crystal composition containing an alignment control material that is highly compatible to other liquid crystal composition, and having excellent alignment restraining force, and discloses forming an alignment control layer by polymerizing a polymerizable compound contained in the liquid crystal composition. Patent Literature 2 discloses polymerizing a multifunctional monomer having a symmetric structure, mixed into the liquid crystal, and vertically aligning the liquid crystal by the obtained ultraviolet cured product. Patent Literature 3 discloses a composition for alignment of liquid crystal containing a norbornene polymer having photo-reactivity, a binder, a reactive mesogen, and a photo initiator.

However, all of Patent Literatures 1 to 3 lack concrete disclosure about a monomer having a chalconyl group represented by Chemical formula (A), and fail to investigate irradiating the monomer having a chalconyl group with polarized ultraviolet rays. In Patent Literature 2, liquid crystal is vertically aligned by an ultraviolet-cured product. However, the liquid crystal display device of the present invention differs from Patent Literature 2 in that the liquid crystal display device has an alignment control layer for aligning the liquid crystal material in the direction horizontal to faces of substrates. Patent Literature 3 discloses a liquid crystal display device having an alignment film, and therefore, it is considered that peeling is likely to occur when the width of the sealing member is narrowed.

### Advantageous Effects of Invention

The liquid crystal display device of the present invention has high peel strength between substrates because a pair of substrates are bonded to each other by a sealing member without a conventional alignment film interposed therebetween. Also, by including an alignment control layer containing a polymer containing a unit derived from a specific monomer, it is possible to keep an excellent voltage holding ratio not only in a normal temperature environment, but also in a high temperature environment.

Also, a method for producing a liquid crystal display device according to the aforementioned aspect of the present invention can produce a liquid crystal display device capable of keeping an excellent voltage holding ratio not only in a normal temperature environment, but also in a high temperature environment because the method includes the step of polymerizing a monomer having a specific structure, to form an alignment control layer at an interface between the pair of substrates and the liquid crystal layer.

### BRIEF DESCRIPTION OF DRAWINGS

FIG. 1 is a schematic cross-sectional view of a liquid crystal display device according to Embodiment 1.

FIG. 2 is a schematic plan view of the liquid crystal display device according to Embodiment 1.

FIG. 3 is a schematic view illustrating the course of forming an alignment control layer in a method for producing the liquid crystal display device of Embodiment 1.

FIG. 4 is a table collectively showing the results of Examples 1-1, 1-2 and Comparative Example 1.

FIG. 5 is a graph showing VT characteristics of Example 1-2 and Example 2-3.

FIG. 6 is a schematic view of a sample for evaluation of adhesive strength.

FIG. 7 is a schematic cross-sectional view of a liquid crystal display device having a conventional alignment film.

### DESCRIPTION OF EMBODIMENTS

Hereinafter, embodiments of the present invention are described. The present invention is not limited to the contents described in the following embodiments, but can be appropriately modified in design within the range that satisfies the configuration of the present invention.

### Embodiment 1

### <Liquid Crystal Display Device>

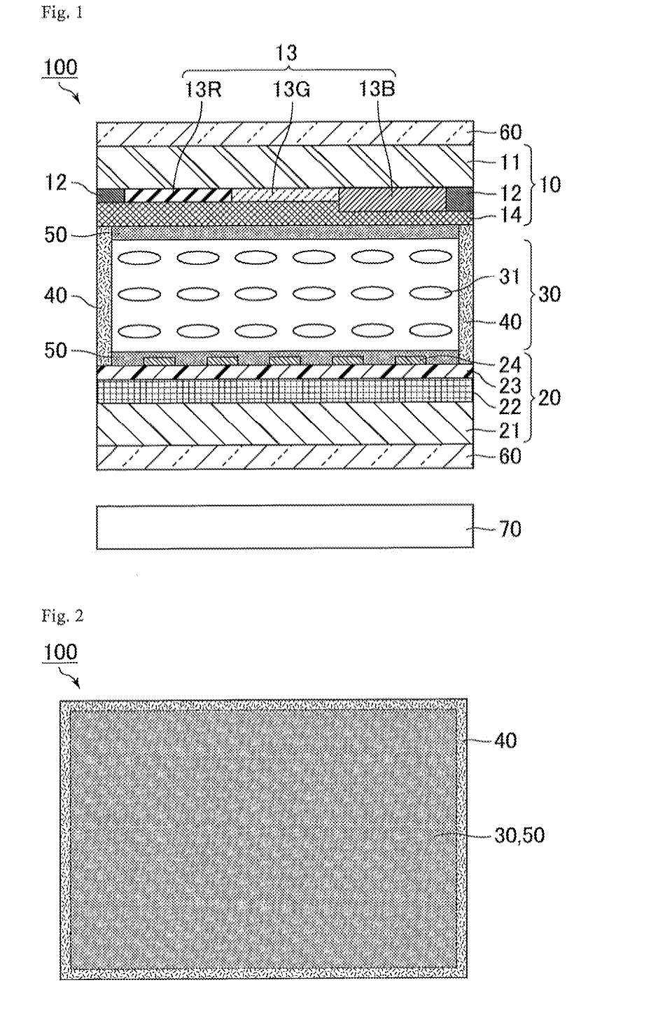

First, referring to FIG. 1 and FIG. 2, a liquid crystal display device of Embodiment 1 is described. FIG. 1 is a schematic cross-sectional view of the liquid crystal display device according to Embodiment 1. FIG. 2 is a schematic plan view of the liquid crystal display device according to Embodiment 1. As shown in FIG. 1 and FIG. 2, the liquid crystal display device of the present embodiment includes a liquid crystal layer 30 containing a liquid crystal material 31, a sealing member 40 disposed to surround the liquid crystal layer 30 in a plan view, a pair of substrates 10 and 20 that are bonded to each other by the sealing member 40 to sandwich the liquid crystal layer 30, and an alignment control layer 50 disposed to be in contact with the liquid crystal layer 30 in a region surrounded by the sealing member 40 in a plan view. The liquid crystal display device of Embodiment 1 further includes a backlight 70 on the back of either one of the pair of substrates 10, 20.

The liquid crystal display device of the present embodiment does not have a conventional alignment film on faces of liquid crystal layer sides of the pair of substrates 10 and 20, and the pair of substrates 10 and 20 are bonded to each other by the sealing member 40. Since the substrates 10 and 20, and the sealing member 40 are in contact with each other without intervention by a conventional alignment film, it is possible to improve the peeling strength, and it is possible to keep the adhesion between the pair of substrates 10 and 20 even when the width of the sealing member 40 is reduced for narrowing the frame area.

While the alignment film is required not to be formed in a position overlapping with the sealing member 40 in a plan view, preferably, the alignment film is not formed on the whole faces of the pair of substrates 10 and 20 because it is difficult not to form an alignment film only in a position overlapping with the sealing member 40 in terms of the accuracy of the printing device used for formation of the alignment film. In the present invention, “alignment film” means a monolayer film or a multilayer film composed of polyimide, polyamic acid, polyamide, polymaleimide, polysiloxane, polysilsesquioxane, polyphosphazene, or a copolymer thereof, or a film of a silicon oxide formed by oblique deposition, capable of controlling alignment of a liquid crystal material. In a general liquid crystal display device, an alignment film is formed by directly applying (applying, for example, polyimide or the like) or vapor depositing (for example, oblique deposition of a silicon oxide (SiO)) an alignment film material on faces of substrates constituting a display area. The alignment film is not limited to those having undergone an alignment treatment as long as an existing film material such as polyimide is applied.

Examples of the pair of substrates 10, 20 include a combination of an active matrix substrate (TFT substrate) and a color filter (CF) substrate.

As the active matrix substrate, those generally used in the field of liquid crystal display device may be used. In one exemplary configuration of the active matrix substrate in a plan view, on a transparent substrate 21, multiple gate signal lines that are parallel with each other; multiple source signal lines that extend in the direction orthogonal to the gate signal lines, and are parallel with each other; active elements such as thin-film transistors (TFT) that are arranged in correspondence with cross-points between the gate signal lines and the source signal lines; pixel electrodes 24 that are arranged in a matrix state in regions partitioned by the gate signal lines and the source signal lines and so on are disposed. In the case of a transverse electric field display mode, a common line, a common electrode 22 connected to the common line, and so on are further provided. The pixel electrode 24 and the common electrode 22 may be stacked with an insulating layer 23 interposed therebetween. As the TFT, those having channels formed of amorphous silicon, polysilicon, or IGZO (indium-gallium-zinc-oxygen) which is an oxide semiconductor are preferably used.

In a display method of active matrix type, generally, a signal voltage is applied on an electrode through a TFT when a TFT provided for each pixel is ON, and an electric charge charged in the pixel at this time is retained in the period in which the TFT is OFF. The ratio of charged electric charges retained in one frame period (for example, 16.7 ms) is indicated by a voltage holding ratio (VHR). In other words, lower VHR means higher probability of attenuation in the voltage applied to the liquid crystal layer with time, and in the display method of active matrix type, it is required to make VHR high.

As a color filter substrate, those generally used in the field of liquid crystal display device may be used. In one exemplary configuration of the color filter substrate, on a transparent substrate 11, a black matrix 12 is formed into a grid pattern, and a color filter 13 or the like formed inside the grid, namely inside the pixel is provided. The color filter 13 may include a red color filter 13R, a green color filter 13G and a blue color filter 13B. The blue color filter 13B may have a larger thickness than the red color filter 13R or the green color filter 13G. By making the thickness of the blue color filter 13B large, it is possible to reduce the thickness of the liquid crystal layer and to optimize the thickness of the cell. On a face of the color filter 13, an over coat layer 14 (dielectric constant 8=3 to 4) for flattening the bumpy face may be disposed. When the color filter substrate has the over coat layer 14, the peel strength of the sealing member does not deteriorate although the over coat layer 14 and the sealing member 40 are in contact with each other.

In the pair of substrates 10, 20, both the color filter and the active matrix may be formed on either one of the substrates.

As shown in FIG. 2, the sealing member 40 is disposed to surround the periphery of the liquid crystal layer 30 in a plan view. The sealing member 40 may be cured by light such as ultraviolet rays, or may be cured by heat, or may be cured by both light and heat. The sealing member 40 may contain an epoxy resin or a (meth)acryl resin, for example. The sealing member 40 may contain an inorganic filler, an organic filler or a curing agent. As the sealing member 40, for example, Photolec available from Sekisui Chemical Co., Ltd. may be used.

The sealing member 40 may have a width in a plan view of 0.4 mm or more and 5 mm or less. A more preferred lower limit of the width of the sealing member 40 is 0.6 mm, and a more preferred upper limit is 4 mm or less, and a further preferred upper limit is 2 mm. The width of the sealing member 40 may be 1.0 mm or less. The substrate 10 and the substrate 20 can be bonded to each other sufficiently even with a width as small as 1.0 mm or less because in the liquid crystal display device of the present embodiment, the substrates 10 and 20, and the sealing member 40 are in direct contact with each other, and the peel strength is high.

The liquid crystal layer 30 contains at least one type of the liquid crystal material 31. The liquid crystal material 31 is thermotropic liquid crystal, and is preferably, a liquid crystal material exhibiting a nematic phase (nematic liquid crystal). The liquid crystal material is preferably the one of which phase transits to the isotropic phase from the nematic phase at a certain critical temperature (nematic phase-isotropic phase transition point (T_{NI})) or higher as the temperature is elevated. It is preferred that the liquid crystal layer 30 exhibits a nematic phase under a service environment (for example, −40° C. to 90° C.) of the liquid crystal display device. Examples of the temperature of the nematic phase-isotropic phase transition point of the liquid crystal material include, but are not limited to, 70 to 110° C. When the liquid crystal material contains a liquid crystal compound having an alkenyl group, the aforementioned T_{NI} is T_{NI} of the liquid crystal material containing the liquid crystal compound having an alkenyl group.

The aforementioned liquid crystal material may be those having a negative value of anisotropy of dielectric constant (Δε) defined by the following formula, or those having a positive value of anisotropy of dielectric constant (Δε). The liquid crystal material may have negative anisotropy of dielectric constant, or may have positive anisotropy of dielectric constant. As the liquid crystal material having negative anisotropy of dielectric constant, for example, those having Δε of −1 to −20 can be used. As the liquid crystal material having positive anisotropy of dielectric constant, for example, those having Δε of 1 to 20 can be used. Further, the liquid crystal layer 30 may contain a liquid crystal material not having polarity, namely a liquid crystal layer having Δε of substantially 0 (neutral liquid crystal material). Examples of the neutral liquid crystal material include a liquid crystal material having an alkene structure.

Δε=(Dielectric constant along long axis)−(Dielectric constant along short axis)

From the viewpoint of keeping high VHR, it is preferred that the liquid crystal material has positive anisotropy of dielectric constant. On the other hand, when the display mode of the liquid crystal display device 100 is a transverse electric field display mode, the liquid crystal material preferably has negative anisotropy of dielectric constant because an excellent contrast ratio is obtained.

The liquid crystal material may contain a liquid crystal compound having an alkenyl group. By containing a liquid crystal compound having an alkenyl group, it is possible to improve the responsibility of the liquid crystal material, and to improve the speed. On the other hand, a liquid crystal compound having an alkenyl group is poor in light resistance, so that it can decompose by irradiation with ultraviolet rays to cause deterioration in VHR. In the present embodiment, the alignment control layer 50 contains a polymer containing a unit derived from a first monomer represented by Chemical formula (A), and the first monomer has a chalconyl group, and expresses an alignment restraining force by polarized ultraviolet rays which are the ultraviolet light only in a uniaxial direction. Therefore, it is possible to largely reduce the intensity of the ultraviolet rays applied to the liquid crystal layer 30 as compared with unpolarized light. Therefore, the problem of reliability such as deterioration in VHR is less likely to occur even when the liquid crystal compound having an alkenyl group is introduced into the liquid crystal material.

The liquid crystal compound having an alkenyl group may be a compound represented by any one of the following Chemical formulas (B-1) to (B-4).

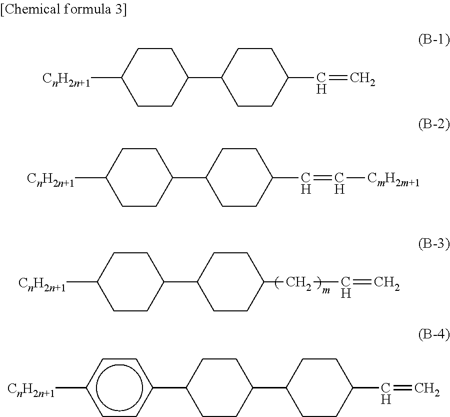

In the formulas, m and n are the same as or different from each other, and each represent an integer of 1 to 6.

Concrete examples of the liquid crystal compound having an alkenyl group include a compound represented by the following Chemical formula (B-1-1).

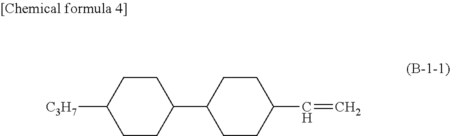

As shown in FIG. 2, the alignment control layer 50 is disposed in a region surrounded by the sealing member 40 in a plan view. The alignment control layer 50 is disposed to be in contact with the liquid crystal layer 30, and the liquid crystal material 31 in the liquid crystal layer 30 is aligned in a direction horizontal to faces of the substrates 10 and 20. Regarding the alignment control layer 50, alignment of the liquid crystal material in the condition that a voltage of a threshold or higher of the liquid crystal material is not applied to the liquid crystal layer 30 is controlled by the alignment control layer 50. Aligning the liquid crystal material 31 in the direction horizontal to faces of the substrates 10 and 20 means that a pre-tilt angle of the liquid crystal material with respect to faces of the substrates 10 and 20 is 10° or less. It is more preferred that the pre-tilt angle is 3° or less. The pre-tilt angle refers to an angle formed by a long axis of the liquid crystal material with respect to a face of substrate at an applied voltage to the liquid crystal layer 30 of less than the threshold voltage (including no application of voltage), and a face of substrate is 0°, and a normal of substrate is 90°.

The alignment control layer 50 contains at least a polymer containing a unit derived from a first monomer represented by Chemical formula (A).

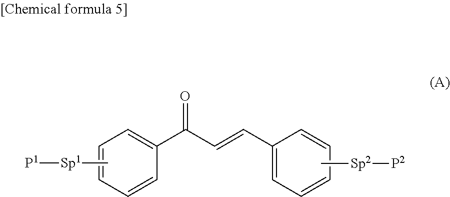

In the formula, P¹ and P² are the same as or different from each other, and each represent an acryloyloxy group, a methacryloyloxy group, an acryloylamino group, a methacryloylamino group, a vinyl group or a vinyloxy group, and

Sp¹ and Sp² are the same as or different from each other, and each represent a linear, branched, or cyclic C1-C6 alkylene group, a linear, branched, or cyclic C1-C6 alkyleneoxy group, or a direct bond.

Having a methacryloyloxy group or a methacryloylamino group as a polymerizable group increases the dose of the polarized ultraviolet rays at the time of forming an alignment control layer, however, the alignment control layer once formed is capable of keeping high alignment stability for a long term. On the other hand, having an acryloyloxy group, an acryloylamino group, a vinyl group, or a vinyloxy group as a polymerizable group provides a horizontal alignment control layer capable of sufficiently controlling the alignment orientation of the liquid crystal material even with a relatively small dose of the polarized ultraviolet rays, so that it is possible to obtain a liquid crystal display device having a high contrast ratio with a smaller dose. Further, since an acryloyloxy group completely becomes aliphatic after polymerization, it is possible to form an alignment control layer having excellent reliability.

The first monomer represented by Chemical formula (A) has a chalconyl group. The chalconyl group is capable of expressing an alignment restraining force by absorbing polarized ultraviolet rays. Irradiation with polarized ultraviolet rays can lower the intensity of light irradiation applied to the liquid crystal layer 30, compared with irradiation with unpolarized light because light made up of only light in the monoaxial direction is applied. Expression of the alignment restraining force by the first monomer enables the alignment control layer 50 to align the liquid crystal material in the direction horizontal to faces of substrates. Also, the first monomer has two polymerizable groups, and polymerizes by irradiation with light such as ultraviolet rays or heating to form a polymer. The phase of the polymer is separated from the liquid crystal layer, so that the alignment control layer 50 is formed.

Concrete examples of the first monomer include monomers represented by the following Chemical formula (A-1) or (A-2).

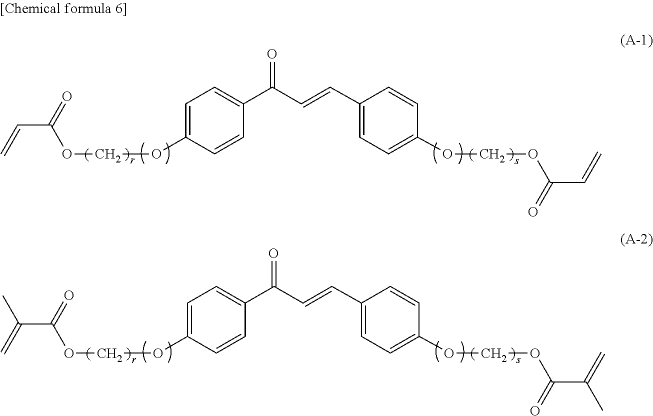

In the formulas, r and s are the same as or different from each other, and each represent an integer of 1 to 6.

More concrete examples of the first monomer include monomers represented by any one of the following Chemical formulas (A-1-1), and (A-2-1) to (A-2-4).

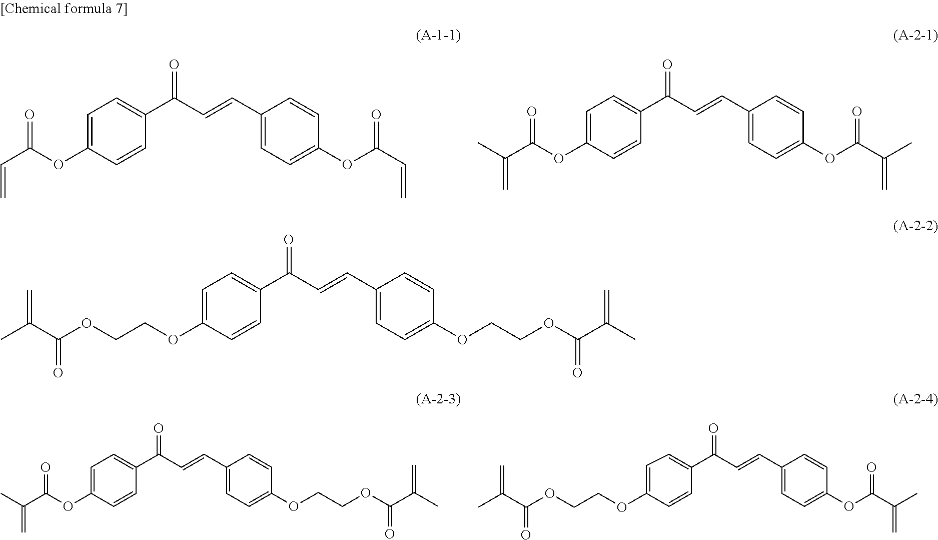

Since radicals are formed by photo Fries rearrangement in the monomers represented by Chemical formulas (A-1-1) and (A-2-1), the monomers polymerize without necessity of a polymerization initiator or a polymerization initiation monomer, and can form the alignment control layer 50. In the monomers represented by Chemical formulas (A-2-2), (A-2-3), and (A-2-4), an alkyl group is introduced between a chalconyl group and a polymerizable group, and the molecular structure is flexible. Therefore, the alignment control layer 50 having more excellent alignability can be obtained.

The aforementioned polymer may further contain a unit derived from a second monomer represented by the following Chemical formula (C). The second monomer is a polymerization initiation monomer, and has a structure of generating a radical by a hydrogen abstraction reaction caused by light irradiation.

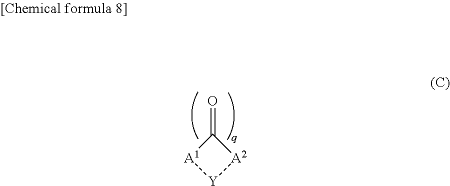

In the formula, A¹ and A² are the same as or different from each other, and each represent a benzene ring, a biphenyl ring, a linear or branched C1-C12 alkyl group, or a linear or branched C1-C12 alkenyl group,

either one of A₁ and A₂ is a benzene ring or a biphenyl ring,

at least one selected from A₁ and A₂ contains an -Sp³-P³ group,

a hydrogen atom of each of A¹ and A² may be replaced by an -Sp³-P³ group, a halogen atom, a —CN group, an —NO₂ group, an —NCO group, an —NCS group, an —OCN group, an —SCN group, an —SF₅ group, a linear or branched C1-C12 alkyl group, a linear or branched C1-C12 alkenyl group, or a linear or branched C1-C12 aralkyl group,

two adjacent hydrogen atoms of each of A¹ and A² may each be replaced by a linear or branched C1-C12 alkylene group, a linear or branched C1-C12 alkenylene group, or a linear or branched C1-C12 aralkyl group to form a cyclic structure,

a hydrogen atom of an alkyl group, an alkenyl group, an alkylene group, an alkenylene group or an aralkyl group of A¹ and A² may be replaced by an -Sp³-P³ group,

a —CH₂— group of an alkyl group, an alkenyl group, an alkylene group, an alkenylene group or an aralkyl group of A¹ and A² may be replaced by an —O— group, an —S— group, an —NH— group, a —CO— group, a —COO— group, an —OCO— group, an —O—COO— group, an —OCH₂— group, a —CH₂O— group, an —SCH₂— group, a —CH₂S— group, an —N(CH₃)— group, an —N(C₂H₅)— group, an —N(C₃H₇)— group, an —N(C₄H₉)— group, a —CF₂O— group, an —OCF₂— group, a —CF₂S— group, an —SCF₂— group, an —N(CF₃)— group, a —CH₂CH₂— group, a —CH₂CF₂— group, a —CF₂CH₂— group, a —CF₂CF₂— group, a —CH═CH— group, a —CF═CF— group, a —C≡C— group, a —CH═CH—COO— group, or an —OCO—CH═CH— group as long as an oxygen atom, a sulfur atom, and a nitrogen atom are not adjacent to one another,

P³ represents a polymerizable group,

Sp³ represents a linear, branched or cyclic C1-C6 alkylene group, or a linear, branched or cyclic C1-C6 alkyleneoxy group, or a direct bond,

q is 1 or 2,

The dotted line part connecting A¹ and Y, and the dotted line part connecting A² and Y indicate that a bond via Y may exist between A¹ and A², and

Y represents a —CH₂— group, a —CH₂CH₂— group, a —CH═CH— group, an —O— group, an —S— group, an —NH— group, an —N(CH₃)— group, an —N(C₂H₅)— group, an —N(C₃H₇)— group, an —N(C₄H₉)— group, an —OCH₂— group, a —CH₂O— group, an —SCH₂— group, a —CH₂S— group, or a direct bond.

A polymerizable group P³ contained in the compound represented by Chemical formula (C) may be a radical polymerizable group. It is preferred that the polymerizable group P³ is an acryloyloxy group, a methacryloyloxy group, an acryloylamino group, a methacryloylamino group, a vinyl group, or a vinyloxy group.

Concrete examples of the second monomer include compounds represented by the following Chemical formulas (C-1) to (C-8).

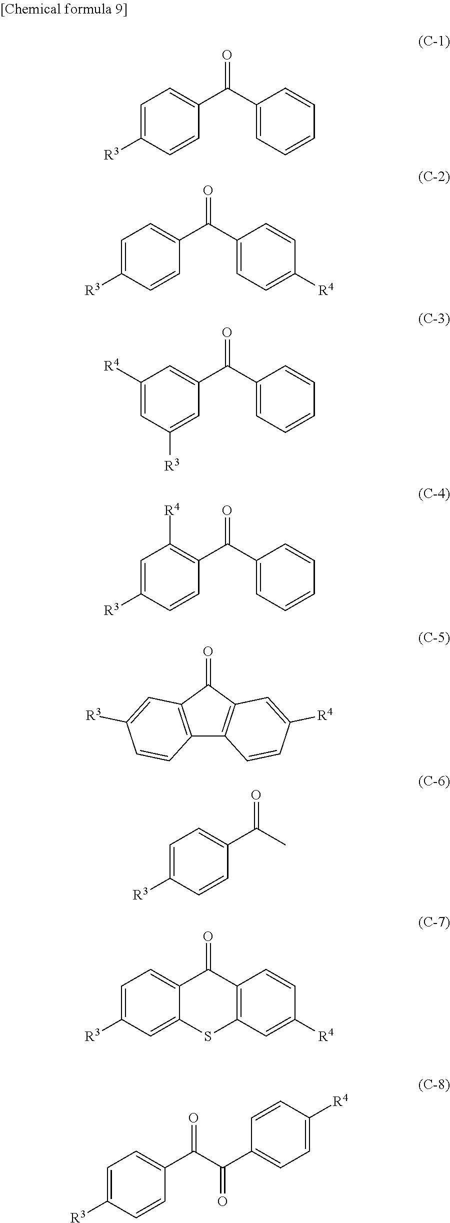

In the formulas, R³ and R⁴ are the same as or different from each other, and each represent an -Sp⁶-P⁶ group, a hydrogen atom, a —CN group, an —NO₂ group, an —NCO group, an —NCS group, an —OCN group, an —SCN group, an —SF₅ group, a linear or branched C1-C12 alkyl group, a linear or branched C1-C12 aralkyl group, or a phenyl group,

at least one selected from R³ and R⁴ contains an -Sp⁶-P⁶ group,

P⁶ represents a radical polymerizable group,

Sp⁶ represents a linear, branched or cyclic C1-C6 alkylene group, a linear, branched or cyclic C1-C6 alkyleneoxy group, or a direct bond,

when at least one selected from R³ and R⁴ is a C1-C12 alkyl group, a linear or branched C1-C12 aralkyl group, or a phenyl group, a hydrogen atom of each of R³ and R⁴ may be replaced by a fluorine atom, a chlorine atom, or an -Sp⁶-P⁶ group, and

a —CH₂— group of each of R³ and R⁴ may be replaced by an —O— group, an —S— group, an —NH— group, a —CO— group, a —COO— group, an —OCO— group, an —O—COO— group, an —OCH₂— group, a —CH₂O— group, an —SCH₂— group, a —CH₂S— group, an —N(CH₃)— group, an —N(C₂H₅)— group, an —N(C₃H₇)— group, an —N(C₄H₉)— group, a —CF₂O— group, an —OCF₂— group, a —CF₂S— group, an —SCF₂— group, an —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, or an —OCO—CH═CH— group as long as an oxygen atom, a sulfur atom, and a nitrogen atom are not adjacent to one another.

It is preferred that the radical polymerizable group P⁶ contained in the compounds represented by Chemical formulas (C-1) to (C-8) is an acryloyloxy group, a methacryloyloxy group, an acryloylamino group, a methacryloylamino group, a vinyl group, or a vinyloxy group.

More concrete examples of the second monomer include a compound represented by the following Chemical formula (C-2-1) or (C-2-2).

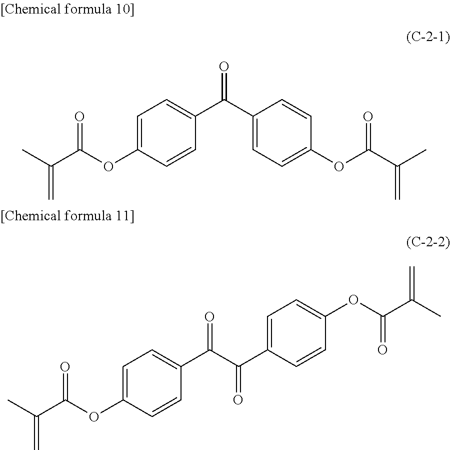

The aforementioned polymer may further contain a unit derived from a third monomer represented by the following Chemical formula (D). The third monomer is a polymerization initiation monomer, and has a structure of generating a radical by a self cleavage reaction caused by light irradiation.

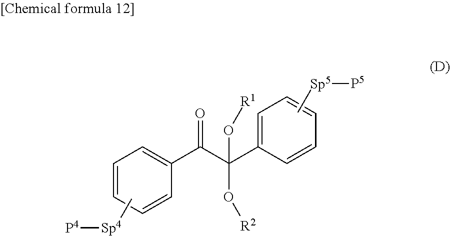

In the formula, R¹ and R² are the same as or different from each other, and each represent a linear or branched C1-C4 alkyl group, or a linear or branched C1-C4 alkenyl group,

P⁴ and P⁵ are the same as or different from each other, and each represent an acryloyloxy group, a methacryloyloxy group, an acryloylamino group, a methacryloylamino group, a vinyl group, or a vinyloxy group, and

Sp⁴ and Sp⁵ are the same as or different from each other, and each represent a linear, branched, or cyclic C1-C6 alkylene group, a linear, branched, or cyclic C1-C6 alkyleneoxy group, a linear, branched, or cyclic C1-C6 alkylenecarbonyloxy group, or a direct bond.

Concrete examples of the third monomer include compounds represented by the following Chemical formula (D-1), and more concrete compounds include compounds represented by the following Chemical formula (D-1-1).

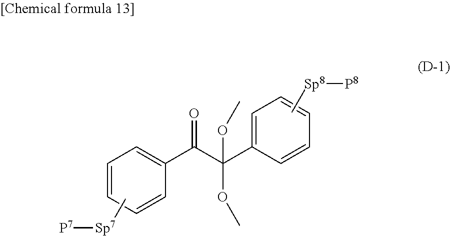

In the formula, P⁷ and P⁸ are the same as or different from each other, and each represent an acryloyloxy group, a methacryloyloxy group, an acryloylamino group, a methacryloylamino group, a vinyl group, or a vinyloxy group, and

Sp⁷ and Sp⁸ are the same as or different from each other, and each represent a linear, branched, or cyclic C1-C6 alkylene group, a linear, branched, or cyclic C1-C6 alkyleneoxy group, or a direct bond.

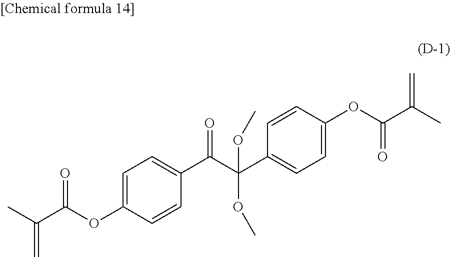 [SMILES: C=C(C)C(=O)Oc1ccc(C(=O)C(OC)(OC)c2ccc(OC(=O)C(=C)C)cc2)cc1]

Using the second monomer or the third monomer which is a polymerization initiation monomer can improve the polymerization speed of the first monomer, so that it is possible to reduce the intensity of light irradiation applied to the liquid crystal layer 30 at the time of forming the alignment control layer 50. Therefore, even when the adding amount of the liquid crystal compound having an alkenyl group having poor light resistance is increased so as to lower the viscosity of the liquid crystal material, it is possible to achieve high speed responsibility while suppressing deterioration in VHR. Since both the second monomer and the third monomer have a polymerizable group, the monomers are likely to be incorporated into an alignment control layer at the time of forming the alignment control layer, and thus are less likely to remain in the liquid crystal layer as impurities. Therefore, they are less likely to cause deterioration in voltage holding ratio (VHR). Even when the second monomer and the third monomer are added to the liquid crystal composition, it is possible to form the alignment control layer 50 by light irradiation, and to conduct a sufficient horizontal alignment control.

A polarizing plate (linear polarizer) 60 may be disposed on each of the pair of substrates 10, 20 on the side opposite to the liquid crystal layer 30. The polarizing plate 60 is typically produced by adsorbing and aligning an anisotropic material such as an iodine complex exhibiting dichroism on a polyvinyl alcohol (PVA) film. Typically, a protective film such as a triacetyl cellulose film is laminated on both faces of the PVA before practical application. Between the polarizing plate 60 and the pair of substrates 10, 20, an optical film such as a phase difference film may be disposed.

As shown in FIG. 1, in the liquid crystal display device of the present embodiment, the backlight 70 is disposed on the back face of the liquid crystal panel. The liquid crystal display device having such a configuration is generally called a transmissive liquid crystal display device. The backlight 70 is not particularly limited as long as it emits light including visible light, and may emit light including only visible light, or may emit light including both visible light and ultraviolet light.

The liquid crystal display device of the present embodiment is made up of multiple members including an external circuit such as TCP (tape carrier package) or PCB (printed circuit board); an optical film such as a viewing angle extending film or a luminance improving film; and bezel (frame) besides the liquid crystal panel and the backlight 70, and a particular member may be incorporated into another member. The members other than the members that have been already described are not particularly limited, and those generally used in the field of liquid crystal display device can be used. Therefore, the description of such members is omitted.

The liquid crystal display device 100 may be in a transverse electric field display mode. Examples of the transverse electric field display mode include an IPS mode, an FFS mode, and an electrically controlled birefringence (ECB) mode.

In the FFS mode, at least one selected from the substrates 10 and 20 is provided with a structure including a planar electrode, a slit electrode, and an insulating film disposed between the planar electrode and the slit electrode (FFS electrode structure), and an oblique electric field (fringe electric field) is formed in the liquid crystal layer 30. Typically, a slit electrode, an insulating film, and a planar electrode are disposed in sequence from the liquid crystal layer 30 side. As the slit electrode, for example, the one having a linear opening as a slit, the entire periphery of the slit being surrounded by the electrode, or the one in a comb shape having multiple comb tooth parts in which a linear cut disposed between comb tooth parts constitutes a slit can be used.

In the IPS mode, for example, a pair of interdigitated electrodes are provided on at least either of the substrates 10 and 20, and a transverse electric field is formed in the liquid crystal layer 30. As the pair of interdigitated electrodes, for example, a pair of electrodes each having multiple comb tooth portions, and arranged in such a manner that the comb tooth portions mutually mesh with each other can be used.

In the ECB mode, for example, either one of the substrates 10 and 20 is provided with a pixel electrode, and the other of the substrates is provided with a counter electrode, and a liquid crystal material having positive anisotropy of dielectric constant is used. By the voltage applied between the pixel electrode and the counter electrode, the retardation of the liquid crystal material is varied, and thus transmission or non-transmission of light is controlled.

<Method for Producing Liquid Crystal Display Device>

Next, a method for producing a liquid crystal display device of the present embodiment is described. The method for producing a liquid crystal display device of the present embodiment may be a method for producing a liquid crystal display device, including a step of sealing a liquid crystal composition containing a liquid crystal material and at least one type of monomer between a pair of substrates bonded to each other by a sealing member to form a liquid crystal layer, and a step of irradiating the liquid crystal layer with polarized ultraviolet rays to form an alignment control layer by polymerization of the at least one type of monomer at an interface between the pair of substrates and the liquid crystal layer, the at least one type of monomer containing a first monomer represented by the following Chemical formula (A), the alignment control layer aligning the liquid crystal material in a direction horizontal to faces of the substrates.

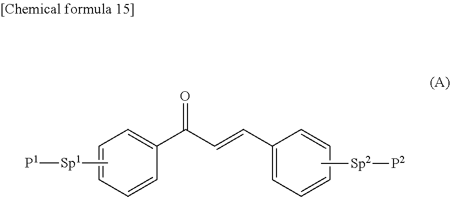

In the formula, P¹ and P² are the same as or different from each other, and each represent an acryloyloxy group, a methacryloyloxy group, an acryloylamino group, a methacryloylamino group, a vinyl group, or a vinyloxy group, and

Sp¹ and Sp² are the same as or different from each other, and each represent a linear, branched, or cyclic C1-C6 alkylene group, a linear, branched, or cyclic C1-C6 alkyleneoxy group, or a direct bond.

Hereinafter, while the steps are described in more detail, the members are as described above, and thus the description thereof is omitted.

The method for producing a liquid crystal display device of the present embodiment includes the step of sealing a liquid crystal composition containing a liquid crystal material and at least one type of monomer between a pair of substrates that are bonded to each other by a sealing member to form a liquid crystal layer. The method for producing a liquid crystal display device of the present embodiment does not include a step of forming an alignment film on faces of a pair of substrates prior to the step of forming a liquid crystal layer. Therefore, the pair of substrates are bonded to each other in such a manner that each substrate is in direct contact with the sealing member without intervention by an alignment film.

In the step of forming a liquid crystal layer, the liquid crystal composition can be sealed in such a manner that the liquid crystal composition is sandwiched between the pair of substrates by the sealing member, and the sealing member may not be cured. Hardening of the sealing member may be carried out separately or at the same time with the step of forming an alignment control layer as will be described later. As described above, the sealing member may be cured by light such as ultraviolet rays, or may be cured by heat, or may be cured by both light and heat.

The liquid crystal layer can be formed by filling the space between the pair of substrates with the liquid crystal composition, for example, by vacuum injection or one drop filling. When the vacuum injection is employed, a liquid crystal layer is formed by conducting application of the sealing member, pasting together of the pair of substrates, curing of the sealing member, injection of the liquid crystal composition, and sealing of the injection port in this order. When the one drop filling is employed, a liquid crystal layer is formed by conducting application of the sealing member, dropping of the liquid crystal composition, pasting together of the pair of substrates, and curing of the sealing member in this order.

As described above, the liquid crystal material may have negative anisotropy of dielectric constant, or may have positive anisotropy of dielectric constant. The liquid crystal material may contain a liquid crystal compound having an alkenyl group. The liquid crystal compound having an alkenyl group may be a compound represented by any one of Chemical formulas (B-1) to (B-4).

The at least one type of monomer contains the first monomer represented by Chemical formula (A). The first monomer represented by Chemical formula (A) has a chalconyl group, and is capable of expressing an alignment restraining force by absorbing polarized ultraviolet rays. Irradiation with polarized ultraviolet rays can lower the intensity of light irradiation applied to the liquid crystal layer, compared with irradiation with unpolarized light because light made up of only light in the monoaxial direction is applied.

Concrete examples of the first monomer include monomers represented by Chemical formula (A-1) or (A-2). More concrete examples of the first monomer include monomers represented by any one of Chemical formulas (A-1-1), and (A-2-1) to (A-2-4).

A first monomer content in the liquid crystal composition may be 0.1% by weight or more, and 10% by weight or less.

The at least one type of monomer may contain the second monomer represented by Chemical formula (C). Concrete examples of the second monomer include compounds represented by Chemical formulas (C-1) to (C-8). More concrete examples of the second monomer include a compound represented by Chemical formula (C-2-1).

A second monomer content in the liquid crystal composition may be 0.01% by weight or more, and 0.5% by weight or less. The mixing ratio of the first monomer and the second monomer may be 5:1 to 1000:1.

The at least one type of monomer may contain the third monomer represented by Chemical formula (D). Concrete examples of the third monomer include compounds represented by Chemical formula (D-1), and more concrete compounds include a compound represented by Chemical formula (D-1-1).

A third monomer content in the liquid crystal composition may be 0.01% by weight or more, and 0.5% by weight or less. The mixing ratio of the first monomer and the third monomer may be 5:1 to 1000:1.

The higher the second monomer content or the third monomer content in the liquid crystal composition, or the higher the mixing ratio of the second monomer or the third monomer to the first monomer, the higher the monomer polymerization speed of the monomer, and the dose of the polarized ultraviolet rays can be reduced. Therefore, it is possible to suppress deterioration in VHR by irradiation with polarized ultraviolet rays. On the other hand, as the second monomer content or mixing ratio or the third monomer content or mixing ratio increases, the alignment in the horizontal alignability decreases, so that the contrast ratio can be decreased. Therefore, in order to improving the alignability of the alignment control layer, it is desired to lower the second monomer content or mixing ratio or the third monomer content or mixing ratio. The second monomer and the third monomer may be used together.

The method for producing a liquid crystal display device of the present embodiment includes a step of irradiating the liquid crystal layer with polarized ultraviolet rays to form an alignment control layer by polymerization of the at least one type of monomer at an interface between the pair of substrates and the liquid crystal layer. It is preferred that the polarized ultraviolet rays are linear polarized ultraviolet rays.

The polarized ultraviolet rays may have a wavelength of 200 nm or more and 430 nm or less. A more preferred lower limit of the wavelength is 250 nm, and a more preferred upper limit is 380 nm. The dose of the polarized ultraviolet rays may be 0.3 J/cm² or more and 20 J/cm² or less. A more preferred lower limit of the dose is 1 J/cm², and a more preferred upper limit is 5 J/cm².

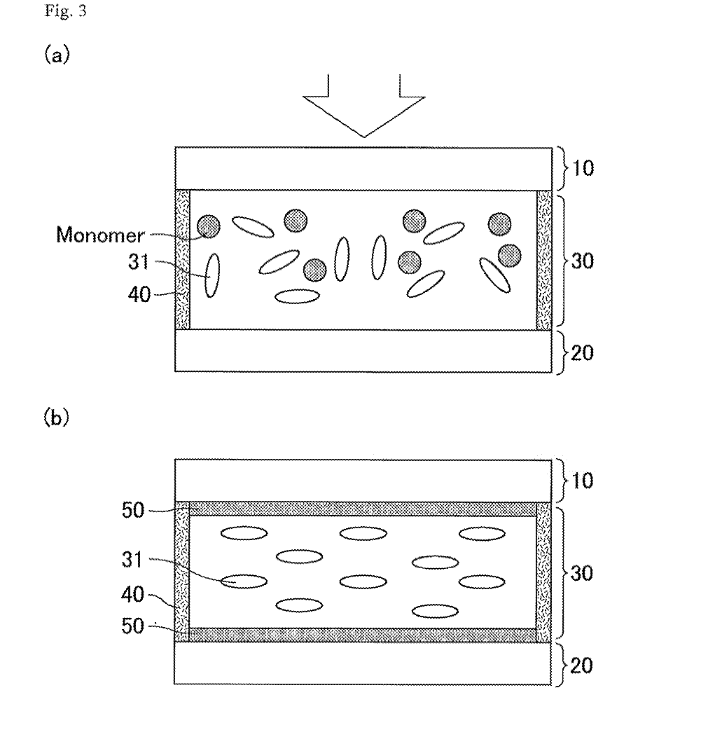

In the step of forming an alignment control layer, polarized ultraviolet rays may be applied while the liquid crystal layer is heated at a temperature of a nematic phase-isotropic phase transition point of the liquid crystal material or higher, and 140° C. or lower. FIG. 3 is a schematic view illustrating the course of forming an alignment control layer in a method for producing the liquid crystal display device of Embodiment 1. FIG. 3(a) illustrates monomers before polymerization, and FIG. 3(b) illustrates monomers after polymerization. In FIG. 3(a), the arrow indicates polarized ultraviolet rays. As illustrated in FIG. 3(a), polarized ultraviolet rays are applied while the liquid crystal layer 30 containing the liquid crystal material 31 and at least one type of monomer is heated. This results in polymerization of the at least one type of monomer and generation of a polymer. Phase separation of the polymer from the liquid crystal layer results in formation of the alignment control layer 50 at an interface between the pair of substrates and the liquid crystal layer as shown in FIG. 3(b).

By heating the liquid crystal layer 30 at a temperature of a nematic phase-isotropic phase transition point (T_{NI}) of the liquid crystal material or higher, it is possible to prevent the condition of the applied polarized ultraviolet rays from changing by the liquid crystal material in the liquid crystal layer, and thus it is possible to produce a liquid crystal display device having a high degree of alignment (high contrast ratio). It is preferred that the heating temperature is higher than the nematic phase-isotropic phase transition point of the liquid crystal material by 3° C. or more. The upper limit of the heating temperature is, for example, 140° C. from the view point of suppressing the thermal deterioration in the liquid crystal material as much as possible. The conditions including heating time and heating means are not particularly limited. The nematic phase-isotropic phase transition point of the liquid crystal material can be measured, for example, by the differential scanning calorimetry (DSC), or by a method of enclosing the liquid crystal material in a capillary and directly observing the temperature dependence.

By having the step of forming an alignment control layer after the step of forming a liquid crystal layer, the pair of substrates sandwiching the liquid crystal layer are bonded to each other by the sealing member, and an alignment control layer can be formed in a region surrounded by the sealing member in a plan view. Also, by polymerizing the first monomer represented by Chemical formula (A) as a monomer for forming an alignment control layer, it is possible to form an alignment control layer that aligns the liquid crystal material in the direction horizontal to faces of the substrates.

The above steps are followed by the step of pasting a polarizing plate, and the step of attaching a controlling unit, a power unit, a backlight and so on to complete the liquid crystal display device of the present embodiment.

When the liquid crystal display device is in a normally black mode, for example, a pair of polarizing plates are arranged on the outer sides of the pair of substrates in a crossed Nicols relationship so that the absorption axes intersect each other at right angles, and the polarizing plates are arranged so that the absorption axis of the polarizing plates and the irradiation axis of the polarized ultraviolet rays form an angle of 0° or 90°. In the condition that a voltage of a threshold or higher is not applied to the liquid crystal layer, the light from the backlight fails to transmit through the liquid crystal layer to give a black state. As a voltage of a threshold or higher is applied to the liquid crystal layer, the angle formed by the absorption axis of the pair of polarizing plates arranged in a crossed Nicols relationship, and the irradiation axis becomes, for example, 45°, so that the light from the backlight transmits through the liquid crystal layer to give a white state. The irradiation axis is a direction of oscillation of the polarized ultraviolet rays. By changing the irradiation direction of the polarized ultraviolet rays with respect to the substrates, it is possible to carry out an alignment dividing treatment.

The liquid crystal display device 100 is preferably in a transverse electric field display mode. Examples of the transverse electric field display mode include an IPS mode, an FFS mode, and an electrically controlled birefringence (ECB) mode.

While embodiments of the present invention have been described above, any individual matters that have been described are applicable to the entirety of the present invention.

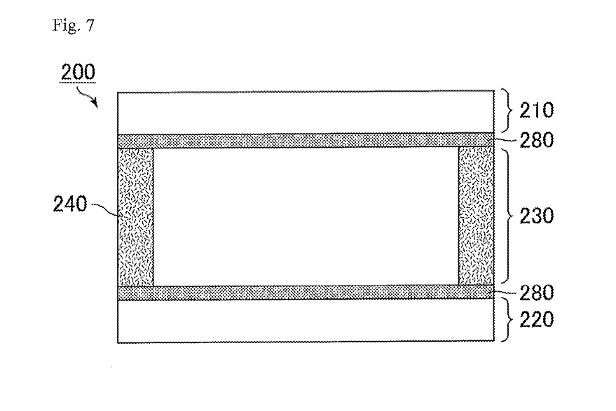

For reference, a configuration of a liquid crystal display device having a conventional alignment film is described by referring to FIG. 7. FIG. 7 is a schematic cross-sectional view of a liquid crystal display device having a conventional alignment film. In a method for producing a liquid crystal display device 200 having an alignment film, typically, an alignment film 280 is formed on faces of a pair of substrates 210 and 220 before the pair of substrates 210 and 220 are pasted together by a sealing member 240. The alignment film 280 can be formed, for example, by applying an alignment film material containing polyamic acid or the like on a face of each of the substrates 210 and 220, and conducting baking after making the solvent in the alignment film material volatilize by heating. Thereafter, the pair of substrates 210 and 220 having the alignment film 280 formed on respective faces are pasted together by the sealing member 240 to form a liquid crystal layer 230. Accordingly, in the liquid crystal display device 200 having a conventional alignment film, the pair of substrates 210 and 220, and the sealing member 240 are intervened by the alignment film 280.

Hereinafter, the present invention is described in more detail based on examples and comparative examples. The examples, however, are not intended to limit the scope of the present invention.

### Example 1-1

### (Preparation of Liquid Crystal Composition)

A first monomer represented by the following Chemical formula (A-1-1) as a monomer for forming an alignment control layer was dissolved in a concentration of 1.0% by weight in a liquid crystal material containing a liquid crystal compound having an alkenyl group (see Chemical formulas (B-1) to (B-4)), and having negative anisotropy of dielectric constant (Δε=−3.0) and a liquid crystal phase-isotropic phase transition point (T_{NI}) of 75° C., and then the resultant mixture was left to stand in an environment at 25° C. for 24 hours to dissolve the first monomer in the liquid crystal material.

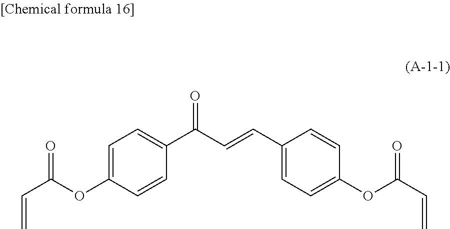 [SMILES: C=CC(=O)Oc1ccc(/C=C/C(=O)c2ccc(OC(=O)C=C)cc2)cc1]

### (Preparation of Liquid Crystal Panel)

A liquid crystal panel in FFS mode was actually prepared in the following manner. First, an ITO substrate in which a pixel electrode having an FFS electrode structure made of indium tin oxide (ITO), an insulating film and a common electrode are laminated, and a counter substrate not having an electrode were prepared. A sealing member (Photolec available from Sekisui Chemical Co., Ltd.) was applied to the ITO substrate, and the liquid crystal composition obtained in the above was dropped in a region surrounded by the sealing member, and then the counter substrate was pasted together to prepare a liquid crystal panel.

Subsequently, the liquid crystal panel was irradiated with linear polarized ultraviolet rays (wavelength of 300 to 380 nm) from the normal direction to the liquid crystal panel at 10 mW/cm² for 100 seconds (1 J/cm²) by using an extra-high pressure mercury lamp (available from USHIO INC.) while the liquid crystal panel was heated to a temperature of T_{NI} (100° C.) or higher, and thus an alignment keeping layer was formed and the sealing member was cured. The sealing member after curing had a width of 0.5 mm. Thereafter, the temperature of the liquid crystal panel was returned to room temperature to prepare a liquid crystal panel in FFS mode not having an alignment film.

### Example 1-2

A liquid crystal panel of Example 1-2 was prepared in the same manner as in Example 1-1 except that in the step of forming an alignment control layer, linear polarized ultraviolet rays were applied at 10 mW/cm² for 200 seconds (2 J/cm²)

### Example 1-3

A liquid crystal panel in FFS mode of Example 1-3 was prepared in the same manner as in Example 1-2 except that a liquid crystal material not containing a liquid crystal compound having an alkenyl group, and having negative anisotropy of dielectric constant (Δε=−3.0) and T_{NI} of 80° C. was used.

### Example 1-4

A liquid crystal panel in FFS mode of Example 1-4 was prepared in the same manner as in Example 1-2 except that in the step of forming an alignment control layer, irradiation with the linear polarized ultraviolet rays was conducted at 30° C. without heating the liquid crystal panel.

### Comparative Example 1

A liquid crystal panel of Comparative Example 1 was prepared in the same manner as in Example 1-1 except that in the step of forming an alignment control layer, linear polarized ultraviolet rays were not applied.

### Comparative Example 2

A liquid crystal panel in FFS mode of Comparative Example 2 was prepared in the same manner as in Example 1-2 except that a liquid crystal material not containing a liquid crystal compound having an alkenyl group, and having negative anisotropy of dielectric constant (Δε=−3.0) and T_{NI} of 80° C. was used, and in the step of forming an alignment control layer, unpolarized ultraviolet rays were applied at 10 mW/cm² for 200 seconds (2 J/cm²)

### <Measurement of Light Transmissive Intensity>

Light transmissive intensity in a black state and light transmissive intensity in a light transmissive state were measured for each liquid crystal panel in FFS mode prepared in Example 1-1 to Example 1-4, Comparative Example 1 and Comparative Example 2. On both sides of each liquid crystal panel, a pair of polarizing plates were arranged in a crossed Nicols relationship so that the absorption axes intersect each other at right angles, and the polarizing plates were arranged so that the angle formed by the absorption axis of the polarizing plates and the irradiation axis of the polarized ultraviolet rays was 00 or 90°, and light transmissive intensity in a black state was measured. Then, the pair of polarizing plates arranged in a crossed Nicols relationship were arranged so that the angle formed by the absorption axis of the pair of polarizing plates and the irradiation axis of the polarized ultraviolet rays was 45°, and light transmissive intensity in a light transmissive state was measured. From the obtained light transmissive intensity, a transmittance ratio was calculated by the following Formula (1). The results are shown in Table 1.

Transmittance ratio=Light transmissive intensity in black state/Light transmissive intensity in light transmissive intensity (1)

TABLE 1

| | | | Alkenyl | | | | |
|---|---|---|---|---|---|---|---|
| | Type | Mon- | group- | | | | |
| | of | omer | containing | | | | Trans- |
| | mon- | content | crystalline | | Irradiation | Dose | mittance |
| | omer | (wt %) | compound | Heating | light | (J/cm²) | ratio |
| Example 1-1 | A-1-1 | 1.0 | Contained | Conducted | Polarized | 1 | 150 |
| | | | | | ultraviolet rays | | |
| Example 1-2 | A-1-1 | 1.0 | Contained | Conducted | Polarized | 2 | 200 |
| | | | | | ultraviolet rays | | |
| Example 1-3 | A-1-1 | 1.0 | Not | Conducted | Polarized | 2 | 200 |
| | | | contained | | ultraviolet rays | | |
| Example 1-4 | A-1-1 | 1.0 | Contained | Not | Polarized | 2 | 20 |
| | | | | conducted | ultraviolet rays | | |
| Comparative | A-1-1 | 1.0 | Contained | Conducted | No irradiation | 0 | 1.1 |
| Example 1 | | | | | | | |
| Comparative | A-1-1 | 1.0 | Not | Conducted | Unpolarized | 2 | 0.96 |
| Example 2 | | | contained | | ultraviolet rays | | |

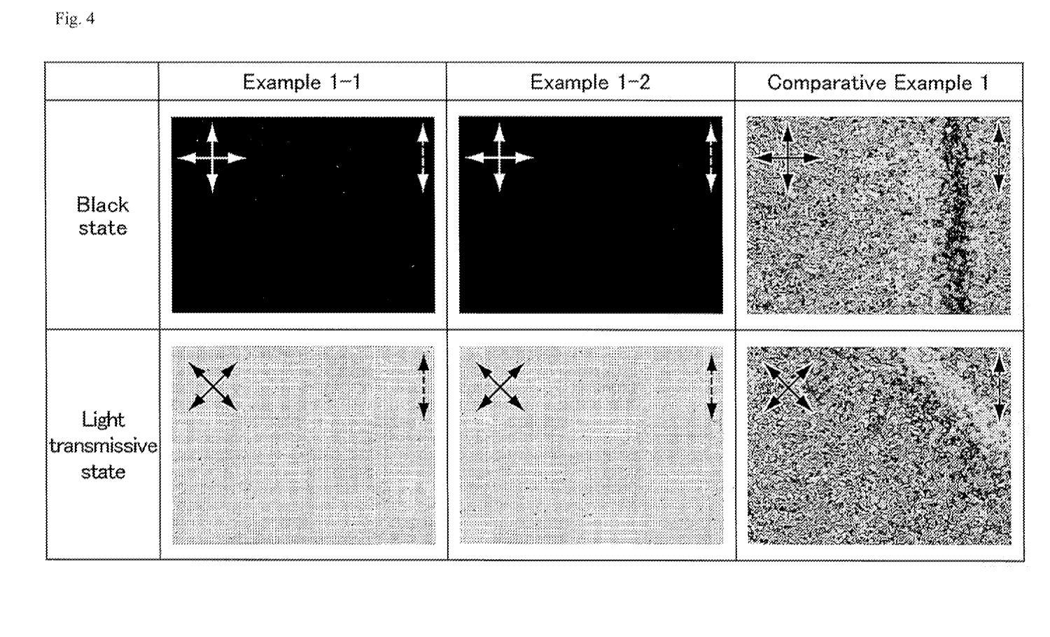

A black state and a light transmissive state of Examples 1-1, 1-2 and Comparative Example 1 were observed with a scanning electron microscope. FIG. 4 is a table collectively showing the results of Examples 1-1, 1-2 and Comparative Example 1. In FIG. 4, the solid double-pointed arrow indicates the absorption axis of the polarizing plates, and the dotted double-pointed arrow indicates the irradiation axis of the linear polarized ultraviolet rays.

Table 1 reveals that in Examples 1-1 to 1-4, by irradiating a liquid crystal panel containing a liquid crystal composition containing the first monomer represented by Chemical formula (A-1-1) with polarized ultraviolet rays, an alignment control layer is formed, and horizontal alignment control is enabled. According to the results of Example 1-2 and Example 1-3, it has been confirmed that the transmittance ratio is not deteriorated even when a compound containing an alkenyl group is added. Focusing on Examples 1-1 and 1-2, as shown in FIG. 4, when the angle formed by the absorption axis of the polarizing plates and the irradiation axis of the linear polarized ultraviolet rays was 0° or 90°, the light did not transmit through the liquid crystal panel, and a black state was presented. When the angle formed by the absorption axis of the polarizing plates and the irradiation axis of the linear polarized ultraviolet rays was 45°, the light transmitted through the liquid crystal panel.

On the other hand, in Comparative Example 1 in which linear polarized ultraviolet rays were not applied, there is little difference in light transmissive intensity between the black state and the light transmissive state, and alignment of the liquid crystal material was not observed. It has also been found that Comparative Example 2 in which unpolarized ultraviolet rays were applied, the light transmittance ratio was low, and horizontal alignment control is not enabled even when the first monomer represented by Chemical formula (A-1-1) is irradiated with the unpolarized ultraviolet rays.

Further, Example 1-2 in which the dose was 2 J/cm² shows a higher transmittance ratio, and less voids of light in black state than Example 1-1 in which the dose was 1 J/cm². As a result, it has been confirmed that the horizontal alignability improves by increasing the dose. According to the results of Example 1-2 and Example 1-4, it has been confirmed that by applying unpolarized ultraviolet rays while heating the liquid crystal panel at a temperature of T_{NI} or higher in the step of forming an alignment control layer, the horizontal alignability greatly improves.

### Example 2-1

A liquid crystal panel in FFS mode of Example 2-1 was prepared in the same manner as in Example 1-2 except that the liquid crystal composition containing the first monomer represented by the following Chemical formula (A-2-1) was used as the monomer for forming an alignment control layer.

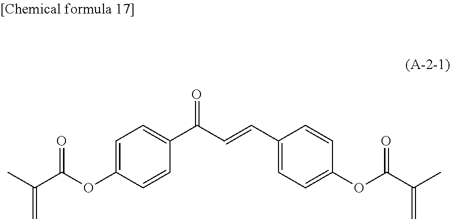 [SMILES: C=C(C)C(=O)Oc1ccc(/C=C/C(=O)c2ccc(OC(=O)C(=C)C)cc2)cc1]

### Example 2-2

A liquid crystal panel in FFS mode of Example 2-2 was prepared in the same manner as in Example 1-2 except that the liquid crystal composition containing a liquid crystal material, a monomer for forming an alignment control layer, and a polymerization initiation polymer was used.

### (Preparation of Liquid Crystal Composition)

In a liquid crystal material containing a liquid crystal compound having an alkenyl group (see Chemical formulas (B-1) to (B-4)), 1.0% by weight of a first monomer represented by the following Chemical formula (A-2-2) as a monomer for forming an alignment control layer, and 0.1% by weight of a second monomer represented by the following Chemical formula (C-2-1) as a polymerization initiation monomer were dissolved, and then the resultant mixture was left to stand in an environment at 25° C. for 24 hours to dissolve the first monomer and the second monomer in the liquid crystal material.

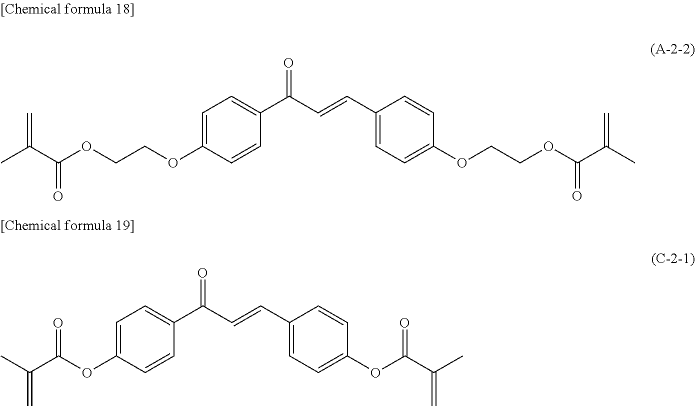

### Example 2-3

A liquid crystal panel in FFS mode of Example 2-3 was prepared in the same manner as in Example 1-2 except that the liquid crystal composition containing a liquid crystal material, a monomer for forming an alignment control layer, and a polymerization initiation polymer was used.

### (Preparation of Liquid Crystal Composition)

In a liquid crystal material containing a liquid crystal compound having an alkenyl group (see Chemical formulas (B-1) to (B-4)), 1.0% by weight of a first monomer represented by the following Chemical formula (A-2-2) as a monomer for forming an alignment control layer, and 0.1% by weight of a third monomer represented by the following Chemical formula (D-1-1) as a polymerization initiation monomer were dissolved, and then the resultant mixture was left to stand in an environment at 25° C. for 24 hours to dissolve the first monomer and the third monomer in the liquid crystal material.

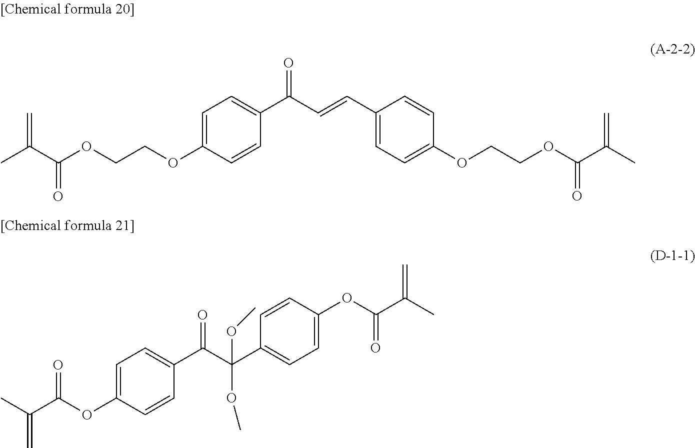

### Comparative Example 3

A liquid crystal panel in FFS mode of Comparative Example 3 was prepared in the same manner as in Example 1-2 except that a liquid crystal composition that contains a liquid crystal material containing a liquid crystal compound having an alkenyl group, but does not contain a monomer for forming an alignment control layer was used.

### Comparative Example 4

A liquid crystal panel in FFS mode of Comparative Example 4 was prepared in the same manner as in Example 1-2 except that in the liquid crystal material containing a liquid crystal compound having an alkenyl group, 0.3% by weight of a monomer not having a chalconyl group represented by the following Chemical formula (F) was dissolved as a monomer for forming an alignment control layer. A saturated solution concentration of the monomer not having a chalconyl group represented by the following Chemical formula (F) is 0.35% by weight.

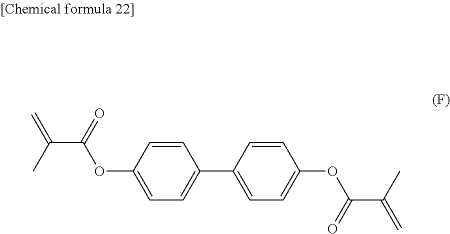 [SMILES: C=C(C)C(=O)Oc1ccc(-c2ccc(OC(=O)C(=C)C)cc2)cc1]

### <Aging Test>

An aging test was conducted by placing a liquid crystal panel in FFS mode prepared in each of Examples 1-2, 2-1 to 2-3, Comparative Example 3 and Comparative Example 4 on an illuminating backlight, and leaving the liquid crystal panel to stand at a temperature of 30° C. for 100 hours. Contrast before the aging test (initial) and voltage holding ratios (VHR) before and after the aging test were measured.

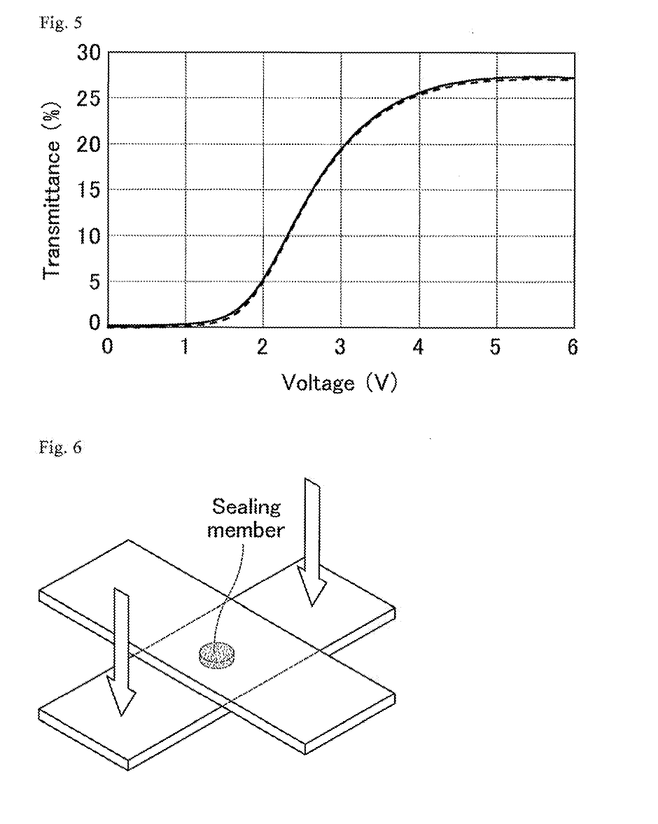

For measuring the contrast ratio, first, VT characteristics were measured by using Photal 5200 (available from OTSUKA ELECTRONICS Co., LTD.). FIG. 5 is a graph showing VT characteristics of Example 1-2 and Example 2-3. In FIG. 5, the horizontal axis indicates voltage (V), and the vertical axis indicates transmittance (%), the variation in transmittance (VT characteristics) for the voltage applied to the liquid crystal layer is shown. In FIG. 5, the dotted line indicates Example 1-2, and the solid line indicates Example 2-3. For each of examples and comparative examples, a contrast ratio was calculated by the transmittance ratio between the applied voltage 5 V (white voltage) and the applied voltage 0 V (black voltage) VHR was measured in the condition of 1 V and 70° C. using a VHR measurement system Model 6254 available from TOYO Corporation. The results are shown in Table 2.

TABLE 2

| | | | | | After |
|---|---|---|---|---|---|
| | | Monomer | Initial (0 hr) | | 100 hrs |
| | Type of | content | Contrast | VHR | VHR |
| | monomer | (wt %) | ratio | (%) | (%) |
| Example 1-2 | A-1-1 | 1.0 | 330 | 95.4 | 92.3 |
| Example 2-1 | A-2-1 | 1.0 | 325 | 96.2 | 93.4 |
| Example 2-2 | A-2-2 | 1.0 | 620 | 97.7 | 95.3 |
| | C-2-1 | 0.1 | | | |
| Example 2-3 | A-2-2 | 1.0 | 675 | 98.0 | 95.9 |
| | D-1-1 | 0.1 | | | |
| Comparative | Monomer not added | | No | 91.5 | 83.6 |
| Example 3 | | | alignment | | |
| Comparative | F | 0.3 | No | 97.5 | 94.1 |
| Example 4 | | | alighment | | |

As shown in Table 2, both Comparative Example 3 in which a monomer for forming an alignment control layer was not added, and Comparative Example 4 using a monomer not having a chalconyl group as a monomer for forming an alignment control layer were unaligned.

Regarding the contrast ratio, the contrast ratio was between 300 and less than 400 in Example 1-2 using the first monomer represented by Chemical formula (A-1-1), and in Example 2-1 using the first monomer represented by Chemical formula (A-2-1), whereas the contrast ratio was between 600 and less than 700 in Example 2-2 using the first monomer represented by Chemical formula (A-2-2), and more excellent result was obtained. This is attributed to that the alignability of the alignment control layer is improved by irradiation with polarized ultraviolet rays since the first monomer represented by Chemical formula (A-2-2) introduces an alkyl group between a chalconyl group and a polymerizable group and imparts flexibility to the molecular structure.

Regarding VHR, high VHR was obtained in Examples 1-2, 2-1 to 2-3 in which a monomer for forming an alignment control layer was added to the liquid crystal composition, compared with Comparative Example 2 in which a monomer for forming an alignment control layer was not added. This is attributed to that deterioration in the liquid crystal material (particularly, liquid crystal compound having an alkenyl group) by irradiation with ultraviolet rays is suppressed since the light applied into the liquid crystal material is polarized ultraviolet rays, and has lower ultraviolet intensity than unpolarized light, and the monomer for forming an alignment control layer absorbs the polarized ultraviolet rays. In comparison between Example 1-2 and Example 2-1, the first monomer represented by Chemical formula (A-2-1) showed higher VHRs before and after the aging test than the first monomer represented by Chemical formula (A-1-1). This is attributed to that photo deterioration such as ionization by degradation of monomer is less likely to occur by using a conjugate methacryl group rather than an acryl group as a polymerizable group. In comparison between Example 1-2, and Example 2-2 and Example 2-3, it has been found that deterioration in VHR after the aging test can be suppressed by using the second monomer represented by Chemical formula (C-2-1) and the third monomer represented by Chemical formula (D-1-1) as the polymerization initiation monomer. This is attributed to that by using the polymerization initiation monomer, the forming speed of the alignment control layer further increases, and absorption of light by the alignment control layer itself reduces the dose of light to the liquid crystal layer, so that photo deterioration in the liquid crystal layer can be efficiently suppressed.

### <Aging Test in High Temperature and High Humidity Environment>

An aging test in a high temperature and high humidity environment (hereinafter, referred to as high temperature and high humidity test) was conducted by placing a liquid crystal panel in FFS mode prepared in each of Examples 1-2, 2-1 to 2-3 and Comparative Example 3 on an illuminating backlight, and leaving the liquid crystal panel to stand at a temperature of 60° C. and at a humidity of 90% for 100 hours, and measuring voltage holding ratios (VHR) before and after the test in the manner as described above. The results are shown in Table 3.

TABLE 3

| | | | High temperature and | |
|---|---|---|---|---|
| | | | high humidity test | |
| | | Monomer | Initial | VHR (%) |
| | Type of | content | (0 hr) | after |
| | monomer | (wt %) | VHR (%) | 100 hrs |
| Example 1-2 | A-1-1 | 1.0 | 95.3 | 91.3 |
| Example 2-1 | A-2-1 | 1.0 | 96.4 | 93.0 |
| Example 2-2 | A-2-2 | 1.0 | 97.8 | 94.1 |
| | C-2-1 | 0.1 | | |
| Example 2-3 | A-2-2 | 1.0 | 98.4 | 94.3 |
| | D-1-1 | 0.1 | | |
| Comparative | Monomer not added | | 91.3 | 85.9 |
| Example 3 | | | | |

In comparison between results of Table 2 and results of Table 3, there was no difference in degree of deterioration in VHR before and after the aging test and before and after the high temperature and high humidity test among Examples 1-2, 2-1 to 2-3 and Comparative Example 3. This reveals that formation of an alignment keeping layer in an alignment film-less liquid crystal display device in which an alignment film is not formed does not cause significant deterioration in VHR particularly in a high temperature and high humidity environment. In Examples 1-2, 2-1 to 2-3 in which a monomer for forming an alignment control layer was added, the higher the initial VHR, the higher the VHR after 100 hours was kept, and the lower the initial VHR, the lower the VHR after 100 hours both in the aging test and the high temperature and high humidity test.

### Example 3-1

A liquid crystal panel in FFS mode of Example 3-1 was prepared in the same manner as in Example 1-2 except that the liquid crystal composition containing a type of the liquid crystal material, a monomer for forming an alignment control layer used in Example 2-3, and a polymerization initiation monomer was used.

### (Preparation of Liquid Crystal Composition)

In the liquid crystal material containing a liquid crystal compound having an alkenyl group, 1.0% by weight of a first monomer represented by Chemical formula (A-2-2) as a monomer for forming an alignment control layer, and 0.1% by weight of a third monomer represented by Chemical formula (D-1-1) as a polymerization initiation monomer were dissolved, and then the resultant mixture was left to stand in an environment at 25° C. for 24 hours to dissolve the first monomer and the third monomer in the liquid crystal material.

### Examples 3-2 to 3-4

A liquid crystal panel in FFS mode of each of Examples 3-2 to 3-4 was prepared in the same manner as in Example 3-1 except that the liquid crystal material shown in Table 4 was used. Likewise Example 3-1, Examples 3-2 to 3-4 also contain in the liquid crystal composition, 1.0% by weight of the first monomer represented by Chemical formula (A-2-2) as the monomer for forming an alignment control layer, and 0.1% by weight of the third monomer represented by Chemical formula (D-1-1) as a polymerization initiation monomer.

### <High Temperature Test on Backlight>

For each liquid crystal panel in FFS mode prepared in Examples 3-1 to 3-4, the contrast ratio before the aging test (initial) and voltage holding ratios (VHR) before and after the aging test were measured in the same manner as in Example 1-2. The results are shown in Table 4.

TABLE 4

| | | | Alkenyl | | | After |
|---|---|---|---|---|---|---|
| | Liquid crystal | | group- | | | 100 |
| | material | | containing | Initial (0 hr) | | hrs |
| | | T_{NI} | crystalline | Contrast | VHR | VHR |
| | Δϵ | (° C.) | compound | ratio | (%) | (%) |
| Example | Negative | 80 | Contained | 675 | 98.4 | 96.3 |
| 3-1 | (−3.0) | | | | | |
| Example | Positive | 85 | Contained | 600 | 99.0 | 98.5 |
| 3-2 | (7.5) | | | | | |
| Example | Positive | 95 | Contained | 610 | 99.0 | 98.5 |
| 3-3 | (3.0) | | | | | |
| Example | Negative | 80 | Not | 670 | 98.5 | 96.7 |
| 3-4 | (−3.0) | | contained | | | |

Regarding the contrast ratio, Example 3-1 and Example 3-4 using a liquid crystal material having negative anisotropy of dielectric constant showed higher values than Example 3-2 and Example 3-3 using a liquid crystal material having positive anisotropy of dielectric constant. It is considered that when a liquid crystal material having positive anisotropy of dielectric constant is used, the liquid crystal material moves in the direction perpendicular to a face of substrate under the influence of the fringe electric field to suppress improvement in transmittance, and the contrast ratio decreases. Since the same tendency is observed also in a liquid crystal display device in FFS mode having an alignment film, it is considered that the decrease in contrast ratio in Example 3-2 and Example 3-3 occurs depending on the relationship between anisotropy of dielectric constant of the liquid crystal material and the alignment mode, and is not caused by the presence or absence of an alignment film.

Regarding VHR, both before and after the aging test, Example 3-2 and Example 3-3 using a liquid crystal material having positive anisotropy of dielectric constant showed higher values than Example 3-1 and Example 3-4 using a liquid crystal material having negative anisotropy of dielectric constant. This is attributed to that incorporation of ionic impurities eluted from a sealing member or the like is generally less likely to occur in a liquid crystal material having positive anisotropy of dielectric constant. There was no difference in VHR between Examples 3-1 to 3-3 using a liquid crystal material containing a liquid crystal compound having an alkenyl group, and Example 3-4 using a liquid crystal material not containing a liquid crystal compound having an alkenyl group. As a result, it has been confirmed that an alignment control layer can be formed without deterioration in VHR even when a liquid crystal compound having an alkenyl group is used as a liquid crystal material and polarized ultraviolet rays are applied. The result of Example 3-3 reveals that an alignment control layer can be formed by heating to 100° C. at the time of irradiation with polarized ultraviolet rays when a liquid crystal material having T_{NI} of 95° C. or higher is used.

From the above, it was confirmed that a liquid crystal display device in FFS mode can be prepared by using a first monomer represented by Chemical formula (A). Since the horizontal alignment of the first monomer can be controlled, liquid crystal display devices in IPS mode and ECB mode which are transverse electric field display modes are also applicable.

### Production Example 1

Two non-acryl glass substrates of 13 mm long and 35 mm wide (hereinafter, glass plates) were prepared, and a sealing member (Photolec available from Sekisui Chemical Co., Ltd.) was dropped on one of the glass plates so that the diameter was 2 mm without formation of an alignment film, and the other of the glass plates was pasted together crosswise in such a manner that the longitudinal directions intersect at right angles. Then after irradiation with ultraviolet rays, heating was conducted to cure the sealing member, and thus a sample for evaluation of adhesive strength was prepared as shown in FIG. 6 to complete Production method 1. FIG. 6 is a schematic view of a sample for evaluation of adhesive strength.

### Reference Example 1

Two glass plates of 13 mm long and 35 mm wide were prepared, and an alignment film composition containing polyamic acid of horizontal alignment type was applied on a face of each of the glass plates. Then, baking at 200° C. for 40 minutes was conducted to form a polyimide horizontal alignment film on the faces of the glass plates. Then the two glass plates were pasted together in the same manner as in Production example 1, and the sealing member was cured to prepare Reference example 1.

### Reference Example 2

Two glass plates of 13 mm long and 35 mm wide were prepared, and an alignment film composition containing polyamic acid of vertical alignment type was applied on a face of each of the glass plates. Then, baking at 200° C. for 40 minutes was conducted to form a polyimide vertical alignment film on the faces of the glass plates. Then the two glass plates were pasted together in the same manner as in Production example 1, and the sealing member was cured to prepare Reference example 2.

### <Adhesive Strength Test>

An aging test in a high temperature and high humidity environment was conducted by placing each of Production example 1, Reference examples 1 and 2 on an illuminating backlight, and leaving to stand at a temperature of 60° C., at a humidity of 90% for 100 hours. Thereafter, adhesive strength before and after the high temperature and high humidity test was measured. Regarding the adhesive strength, as shown in FIG. 6, a load was applied on either one of the two glass plates that were pasted together crosswise (the arrow outline with a blank inside), and an adhesive strength was measured when either of the glass plates and the sealing member peeled off from each other. The results are shown in Table 5.

TABLE 5

| | | Adhesion | Adhesion |
|---|---|---|---|
| | | strength | strength |
| | | before high | after high |
| | | temperature | temperature |
| | | and high | and high |
| | Type of alignment | humidity test | humidity test |
| | film | (kgf/mm) | (kgf/mm) |
| Production | No alignment film | 2.8 | 2.8 |
| example 1 | | | |
| Reference | Polyimide horizontal | 2.6 | 1.5 |
| example 1 | alignment film | | |
| Reference | Polyimide vertical | 1.1 | 0.2 or less |
| example 2 | alignment film | | |

Referring to the results in Table 5, Reference example 1 in which a polyimide horizontal alignment film was formed showed an initial adhesive strength of 2.6 kgf/mm, which was comparable with the adhesive strength (2.8 kgf/mm) of Production example 1 in which an alignment film was not formed, whereas, the adhesive strength after the high temperature and high humidity test in Reference example 1 significantly deteriorated to 1.5 kgf/mm. Reference example 2 in which a polyimide vertical alignment film was formed, the initial adhesive strength was 1.1 kgf/mm, which was lower than those in Reference example 1 and Production example 1. The adhesive strength after the high temperature and high humidity test of Reference example 2 further deteriorated to 0.2 kgf/mm or less. Production example 1 in which an alignment film was not formed, the initial adhesive strength was as high as 2.8 kgf/mm, and the adhesive strength did not deteriorate and kept a value as high as 2.8 kgf/mm even after the high temperature and high humidity test. These results demonstrated that it is effective to use a substrate not having a conventional horizontal alignment film or vertical alignment film as a substrate for a liquid crystal display device in order to keep high adhesive strength even when the width of the sealing member is narrowed due to narrowing of frame.

### [Additional Remarks]

One aspect of the present invention may be a liquid crystal display device including a liquid crystal layer containing a liquid crystal material, a sealing member disposed to surround the liquid crystal layer in a plan view, a pair of substrates that are bonded to each other by the sealing member, and sandwich the liquid crystal layer, and an alignment control layer disposed to be in contact with the liquid crystal layer in a region surrounded by the sealing member in a plan view, the alignment control layer aligning the liquid crystal layer in a direction horizontal to faces of the substrates, and containing a polymer containing at least an unit derived from a first monomer represented by the following Chemical formula (1). The liquid crystal display device has high peel strength between substrates because the pair of substrates are bonded to each other by a sealing member without a conventional alignment film interposed therebetween. Since the first monomer represented by the following Chemical formula (1) has a chalconyl group, and is capable of absorbing the polarized ultraviolet rays to express the alignment restraining force, the intensity of light irradiation applied to the liquid crystal layer can be made lower compared with irradiation with unpolarized light.

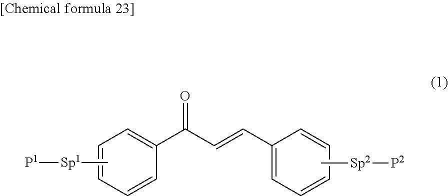

wherein, P¹ and P² are the same as or different from each other, and each represent an acryloyloxy group, a methacryloyloxy group, an acryloylamino group, a methacryloylamino group, a vinyl group, or a vinyloxy group, and

Sp¹ and Sp² are the same as or different from each other, and each represent a linear, branched, or cyclic C1-C6 alkylene group, a linear, branched, or cyclic C1-C6 alkyleneoxy group, or a direct bond.

In one aspect of the present invention, the first monomer may be a monomer represented by either one of the following Chemical formulas (2-1) to (2-5). The monomers represented by the following Formulas (2-1) and (2-2) polymerize without necessity of a polymerization initiator or a polymerization initiation monomer, and can form an alignment control layer. In the monomers represented by Chemical formulas (2-3), (2-4), and (2-5), an alkyl group is introduced between a chalconyl group and a polymerizable group, and the molecular structure is flexible. Therefore, an alignment control layer having more excellent alignability can be obtained.

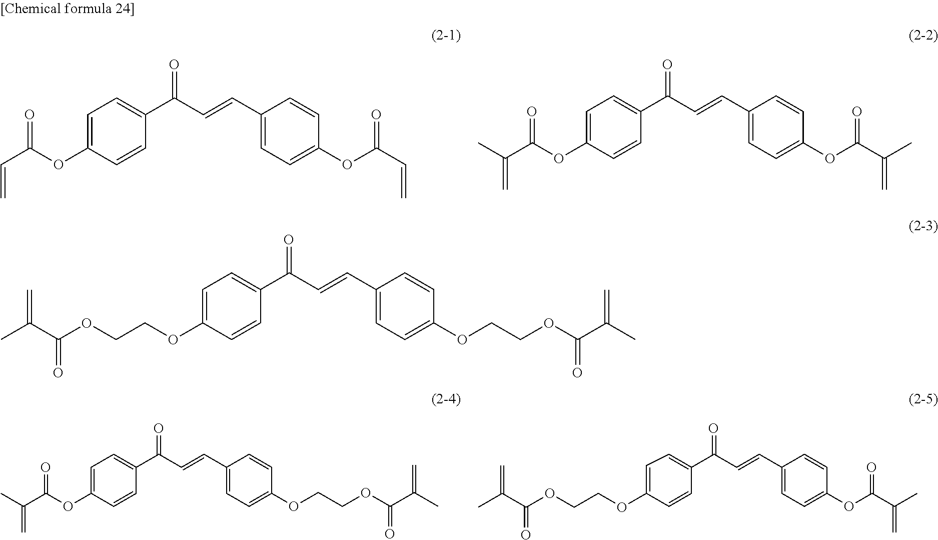

In one aspect of the present invention, the polymer may further contain a unit derived from a second monomer represented by the following Chemical formula (3). Since the second monomer is capable of improving the polymerization speed of the first monomer, it is possible to reduce the intensity of light irradiation applied to the liquid crystal layer at the time of forming the alignment control layer.

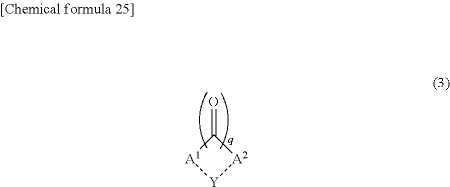

In the formula, A¹ and A² are the same as or different from each other, and each represent a benzene ring, a biphenyl ring, a linear or branched C1-C12 alkyl group, or a linear or branched C1-C12 alkenyl group,

either one of A₁ and A₂ is a benzene ring or a biphenyl ring,

at least one selected from A₁ and A₂ contains an -Sp³-P³ group,

a hydrogen atom of each of A¹ and A² may be replaced by an -Sp³-P³ group, a halogen atom, a —CN group, an —NO₂ group, an —NCO group, an —NCS group, an —OCN group, an —SCN group, an —SF₅ group, a linear or branched C1-C12 alkyl group, a linear or branched C1-C12 alkenyl group, or a linear or branched C1-C12 aralkyl group. Two adjacent hydrogen atoms of A¹ and A² may be replaced by a linear or branched C1-C12 alkylene group, a linear or branched C1-C12 alkenylene group, or a linear or branched C1-C12 aralkyl group to form a cyclic structure,

a hydrogen atom of an alkyl group, an alkenyl group, an alkylene group, an alkenylene group, or an aralkyl group of A¹ and A² may be replaced by an -Sp³-P³ group,

a —CH₂— group of an alkyl group, an alkenyl group, an alkylene group, an alkenylene group, or an aralkyl group of A¹ and A² may be replaced by an —O— group, an —S— group, an —NH— group, a —CO— group, a —COO— group, an —OCO— group, an —O—COO— group, an —OCH₂— group, a —CH₂O— group, an —SCH₂— group, a —CH₂S— group, an —N(CH₃)— group, an —N(C₂H₅)— group, an —N(C₃H₇)— group, an —N(C₄H₉)— group, a —CF₂O— group, an —OCF₂— group, a —CF₂S— group, an —SCF₂— group, an —N(CF₃)— group, a —CH₂CH₂— group, a —CH₂CF₂— group, a —CF₂CH₂— group, a —CF₂CF₂— group, a —CH═CH— group, a —CF═CF— group, a —C≡C— group, a —CH═CH—COO— group, or an —OCO—CH═CH— group as long as an oxygen atom, a sulfur atom, and a nitrogen atom are not adjacent to one another,

P³ represents a polymerizable group,

Sp³ represents a linear, branched, or cyclic C1-C6 alkylene group, a linear, branched, or cyclic C1-C6 alkyleneoxy group, or a direct bond,

q is 1 or 2,

the dotted line part connecting A¹ and Y, and the dotted line part connecting A² and Y indicate that a bond via Y may exist between A¹ and A², and

Y represents a —CH₂— group, a —CH₂CH₂— group, a —CH═CH— group, an —O— group, an —S— group, an —NH— group, an —N(CH₃)— group, an —N(C₂H₅)— group, an —N(C₃H₇)— group, an —N(C₄H₉)— group, an —OCH₂— group, a —CH₂O— group, an —SCH₂— group, a —CH₂S— group, or a direct bond.

In one aspect of the present invention, the polymer may further contain a unit derived from a third monomer represented by the following Chemical formula (4). Since the third monomer is capable of improving the polymerization speed of the first monomer, it is possible to reduce the intensity of light irradiation applied to the liquid crystal layer at the time of forming the alignment control layer.

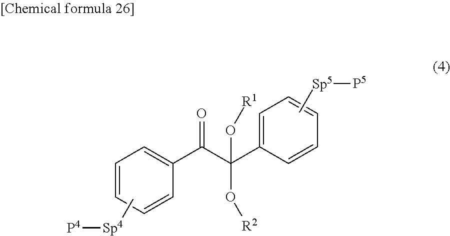

In the formula, R¹ and R² are the same as or different from each other, and each represent a linear or branched C1-C4 alkyl group, or a linear or branched C1-C4 alkenyl group,

P⁴ and P⁵ are the same as or different from each other, and each represent an acryloyloxy group, a methacryloyloxy group, an acryloylamino group, a methacryloylamino group, a vinyl group, or a vinyloxy group, and

Sp⁴ and Sp⁵ are the same as or different from each other, and each represent a linear, branched, or cyclic C1-C6 alkylene group, a linear, branched, or cyclic C1-C6 alkyleneoxy group, a linear, branched, or cyclic C1-C6 alkylenecarbonyloxy group, or a direct bond.

In one aspect of the present invention, the liquid crystal material may contain a liquid crystal compound having an alkenyl group. By containing a liquid crystal compound having an alkenyl group, it is possible to improve the responsibility of the liquid crystal material, and to improve the speed.

In one aspect of the present invention, the liquid crystal compound having an alkenyl group may be a compound represented by either one of the following Chemical formulas (5-1) to (5-4).

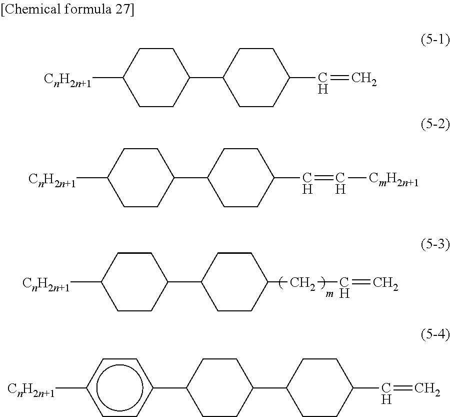

In the formulas, m and n are the same as or different from each other, and each represent an integer of 1 to 6.

In one aspect of the present invention, the liquid crystal display device may be in a transverse electric field display mode.

Another aspect of the present invention may be a method for producing a liquid crystal display device, including a step of sealing a liquid crystal composition containing a liquid crystal material and at least one type of monomer between a pair of substrates bonded to each other by a sealing member to form a liquid crystal layer, and a step of irradiating the liquid crystal layer with polarized ultraviolet rays to form an alignment control layer by polymerization of the at least one type of monomer at an interface between the pair of substrates and the liquid crystal layer, the at least one type of monomer containing a first monomer represented by the following Chemical formula (1), the alignment control layer aligning the liquid crystal material in a direction horizontal to faces of the substrates.

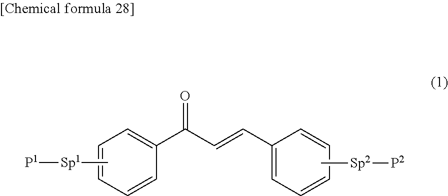

In the formula, P¹ and P² are the same as or different from each other, and each represent an acryloyloxy group, a methacryloyloxy group, an acryloylamino group, a methacryloylamino group, a vinyl group, or a vinyloxy group, and

Sp¹ and Sp² are the same as or different from each other, and each represent a linear, branched, or cyclic C1-C6 alkylene group, a linear, branched, or cyclic C1-C6 alkyleneoxy group, or a direct bond.

In another aspect of the present invention, the first monomer may be a monomer represented by either one of the following Chemical formulas (2-1) to (2-5).

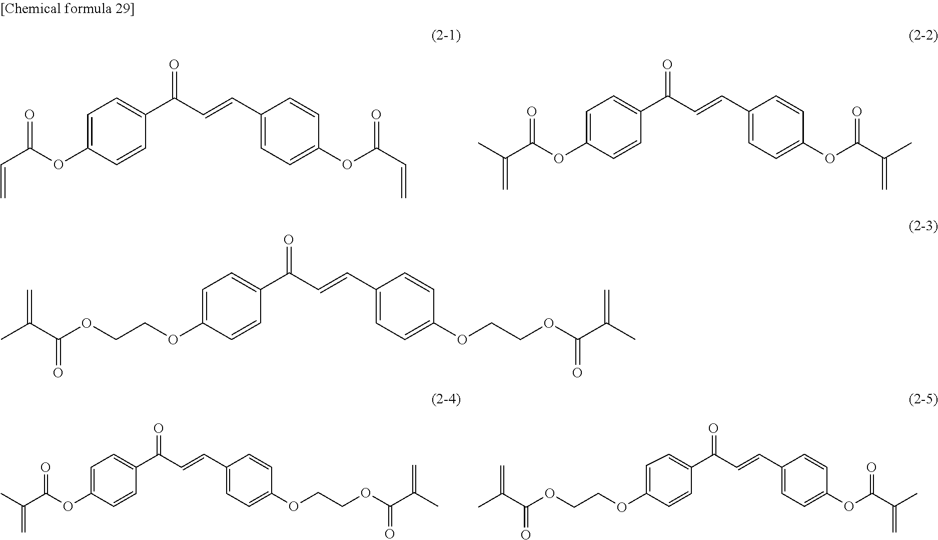

In another aspect of the present invention, the at least one type of monomer may contain a second monomer represented by Chemical formula (3).

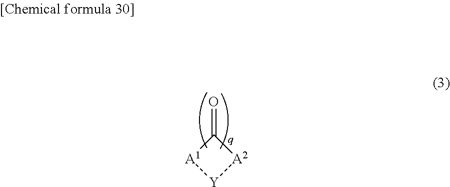

In the formula, A¹ and A² are the same as or different from each other, and each represent a benzene ring, a biphenyl ring, a linear or branched C1-C12 alkyl group, or a linear or branched C1-C12 alkenyl group,

either one of A₁ and A₂ is a benzene ring or a biphenyl ring,

at least one selected from A₁ and A₂ contains an -Sp³⁻P³ group,

a hydrogen atom of each of A¹ and A² may be replaced by an -Sp³-P³ group, a halogen atom, a —CN group, an —NO₂ group, an —NCO group, an —NCS group, an —OCN group, an —SCN group, an —SF₅ group, a linear or branched C1-C12 alkyl group, a linear or branched C1-C12 alkenyl group, or a linear or branched C1-C12 aralkyl group,

two adjacent hydrogen atoms of each of A¹ and A² may each be replaced by a linear or branched C1-C12 alkylene group, a linear or branched C1-C12 alkenylene group, or a linear or branched C1-C12 aralkyl group to form a cyclic structure,

a hydrogen atom of an alkyl group, an alkenyl group, an alkylene group, an alkenylene group, or an aralkyl group of A¹ and A² may be replaced by an -Sp³-P³ group,

a —CH₂— group of an alkyl group, an alkenyl group, an alkylene group, an alkenylene group or an aralkyl group of A¹ and A² may be replaced by an —O— group, an —S— group, an —NH— group, a —CO— group, a —COO— group, an —OCO— group, an —O—COO— group, an —OCH₂— group, a —CH₂O— group, an —SCH₂— group, a —CH₂S— group, an —N(CH₃)— group, an —N(C₂H₅)— group, an —N(C₃H₇)— group, an —N(C₄H₉)— group, a —CF₂O— group, an -OCF₂— group, a —CF₂S— group, an —SCF₂— group, an —N(CF₃)— group, a —CH₂CH₂— group, a —CH₂CF₂— group, a —CF₂CH₂— group, a —CF₂CF₂— group, a —CH═CH— group, a —CF═CF— group, a —C≡C— group, a —CH═CH—COO— group, or an —OCO—CH═CH— group as long as an oxygen atom, a sulfur atom, and a nitrogen atom are not adjacent to one another,

P³ represents a polymerizable group,

Sp³ represents a linear, branched, or cyclic C1-C6 alkylene group, a linear, branched, or cyclic C1-C6 alkyleneoxy group, or a direct bond,

q is 1 or 2,

the dotted line part connecting A¹ and Y, and the dotted line part connecting A² and Y indicate that a bond via Y may exist between A¹ and A², and

Y represents a —CH₂— group, a —CH₂CH₂— group, a —CH═CH— group, an —O— group, an —S— group, an —NH— group, an —N(CH₃)— group, an —N(C₂H₅)— group, an —N(C₃H₇)— group, an —N(C₄H₉)— group, an —OCH₂— group, a —CH₂O— group, an —SCH₂— group, a —CH₂S— group, or a direct bond.

In another aspect of the present invention, the at least one type of monomer may contain a third monomer represented by Chemical formula (4).

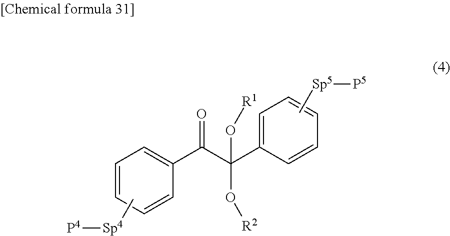

In the formula, R¹ and R² are the same as or different from each other, and each represent a linear or branched C1-C4 alkyl group, or a linear or branched C1-C4 alkenyl group,

P⁴ and P⁵ are the same as or different from each other, and each represent an acryloyloxy group, a methacryloyloxy group, an acryloylamino group, a methacryloylamino group, a vinyl group, or a vinyloxy group, and

Sp⁴ and Sp⁵ are the same as or different from each other, and each represent a linear, branched, or cyclic C1-C6 alkylene group, a linear, branched, or cyclic C1-C6 alkyleneoxy group, a linear, branched, or cyclic C1-C6 alkylenecarbonyloxy group, or a direct bond.

In another aspect of the present invention, polarized ultraviolet rays may be applied while the liquid crystal layer is heated at a temperature of a nematic phase-isotropic phase transition point of the liquid crystal material or higher and 140° C. or lower.

These aspects of the present invention described above may appropriately be combined within the spirit of the present invention.

### REFERENCE SIGNS LIST

10, 20, 210, 220: substrate
21, 11: transparent substrate
12: black matrix
13: color filter
14: over coat layer
22: common electrode
23: insulating layer
24: pixel electrode
30, 230: liquid crystal layer
31: liquid crystal material
40, 240: sealing member
50: alignment control layer
60: polarizing plate
70: backlight
100, 200: liquid crystal display device
280: alignment film

1. A liquid crystal display device comprising:
a liquid crystal layer containing a liquid crystal material;
a sealing member disposed to surround the liquid crystal layer in a plan view;
a pair of substrates that are bonded to each other by the sealing member, and sandwich the liquid crystal layer; and
an alignment control layer disposed to be in contact with the liquid crystal layer in a region surrounded by the sealing member in a plan view,
the alignment control layer aligning the liquid crystal material in a direction horizontal to faces of the substrates, and containing a polymer containing at least a unit derived from a first monomer represented by the following Chemical formula (1): 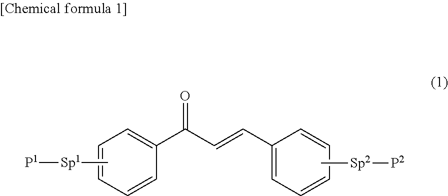
wherein P¹ and P² are the same as or different from each other, and each represent an acryloyloxy group, a methacryloyloxy group, an acryloylamino group, a methacryloylamino group, a vinyl group, or a vinyloxy group, and
Sp¹ and Sp² are the same as or different from each other, and each represent a linear, branched, or cyclic C1-C6 alkylene group, a linear, branched, or cyclic C1-C6 alkyleneoxy group, or a direct bond.

2. The liquid crystal display device according to claim 1,
wherein the first monomer is a monomer represented by any one of the following Chemical formulas (2-1) to (2-5):

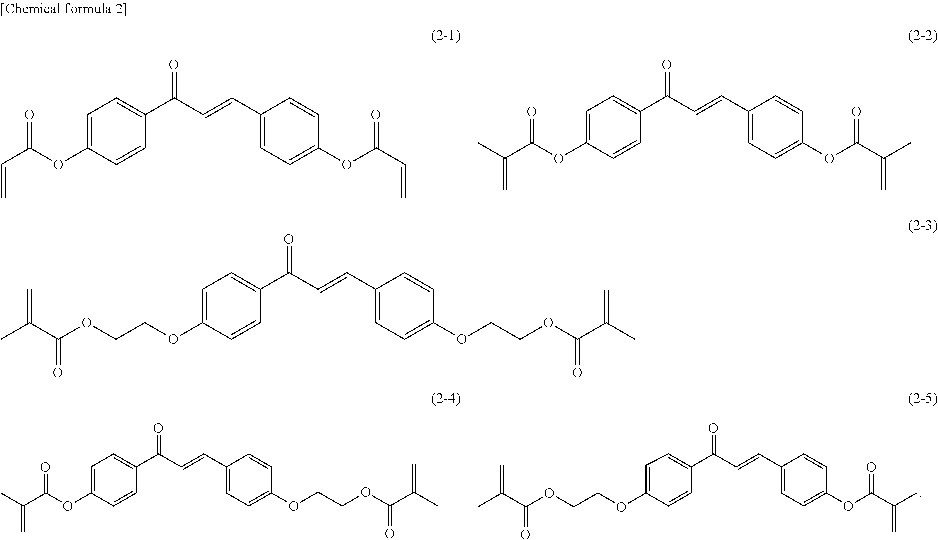

3. The liquid crystal display device according to claim 1,
wherein the polymer further contains a unit derived from a second monomer represented by the following Chemical formula (3): 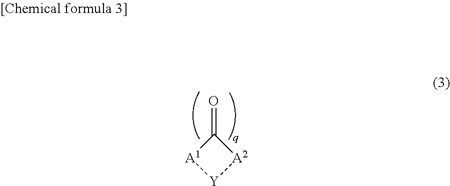
wherein, A¹ and A² are the same as or different from each other, and each represent a benzene ring, a biphenyl ring, a linear or branched C1-C12 alkyl group, or a linear or branched C1-C12 alkenyl group,
either one of A₁ and A₂ is a benzene ring or a biphenyl ring,
at least one selected from A₁ and A₂ contains an -Sp³-P³ group,
a hydrogen atom in each of A¹ and A² may be replaced by an -Sp³-P³ group, a halogen atom, a —CN group, an —NO₂ group, an —NCO group, an —NCS group, an —OCN group, an —SCN group, an —SF₅ group, a linear or branched C1-C12 alkyl group, a linear or branched C1-C12 alkenyl group, or a linear or branched C1-C12 aralkyl group,
two adjacent hydrogen atoms in each of A¹ and A² may each be replaced by a linear or branched C1-C12 alkylene group, a linear or branched C1-C12 alkenylene group, or a linear or branched C1-C12 aralkyl group to form a cyclic structure,
a hydrogen atom of an alkyl group, an alkenyl group, an alkylene group, an alkenylene group, or an aralkyl group of each of A¹ and A² may be replaced by an -Sp³-P³ group,
a —CH₂— group of an alkyl group, an alkenyl group, an alkylene group, an alkenylene group, or an aralkyl group of each of A¹ and A² may be replaced by an —O— group, an —S— group, an —NH— group, a —CO— group, a —COO— group, an —OCO— group, an —O—COO— group, an —OCH₂— group, a —CH₂O— group, an —SCH₂— group, a —CH₂S— group, an —N(CH₃)— group, an —N(C₂H₅)— group, an —N(C₃H₇)— group, an —N(C₄H₉)— group, a —CF₂O— group, an —OCF₂— group, a —CF₂S— group, an —SCF₂— group, an —N(CF₃)— group, a —CH₂CH₂— group, a —CH₂CF₂— group, a —CF₂CH₂— group, a —CF₂CF₂— group, a —CH═CH— group, a —CF═CF— group, a —C≡C— group, a —CH═CH—COO— group, or an —OCO—CH═CH— group as long as an oxygen atom, a sulfur atom, and a nitrogen atom are not adjacent to one another,
P³ represents a polymerizable group,
Sp³ represents a linear, branched, or cyclic C₁-C₆ alkylene group, or a linear, branched, cyclic C₁-C₆ alkyleneoxy group, or a direct bond,
q is 1 or 2,
the dotted line part connecting A¹ and Y, and the dotted line part connecting A² and Y indicate that a bond via Y may exist between A¹ and A², and
Y represents a —CH₂— group, a —CH₂CH₂— group, a —CH═CH— group, an —O— group, an —S— group, an —NH— group, an —N(CH₃)— group, an —N(C₂H₅)— group, an —N(C₃H₇)— group, an —N(C₄H₉)— group, an —OCH₂— group, a —CH₂O— group, an —SCH₂— group, a —CH₂S— group, or a direct bond.

4. The liquid crystal display device according to claim 1,
wherein the polymer further contains a unit derived from a third monomer represented by the following Chemical formula (4): 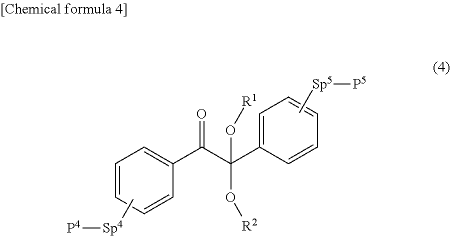
wherein R¹ and R² are the same as or different from each other, and each represent a linear or branched C1-C4 alkyl group, or a linear or branched C1-C4 alkenyl group,
P⁴ and P⁵ are the same as or different from each other, and each represent an acryloyloxy group, a methacryloyloxy group, an acryloylamino group, a methacryloylamino group, a vinyl group, or a vinyloxy group, and
Sp⁴ and Sp⁵ are the same as or different from each other, and each represent a linear, branched, or cyclic C1-C6 alkylene group, a linear, branched, or cyclic C1-C6 alkyleneoxy group, a linear, branched, or cyclic C1-C6 alkylenecarbonyloxy group, or a direct bond.

5. The liquid crystal display device according to claim 1,
wherein the liquid crystal material contains a liquid crystal compound containing an alkenyl group.

6. The liquid crystal display device according to claim 5,
wherein the liquid crystal compound containing an alkenyl group is a compound represented by any one of the following Chemical formulas (5-1) to (5-4): 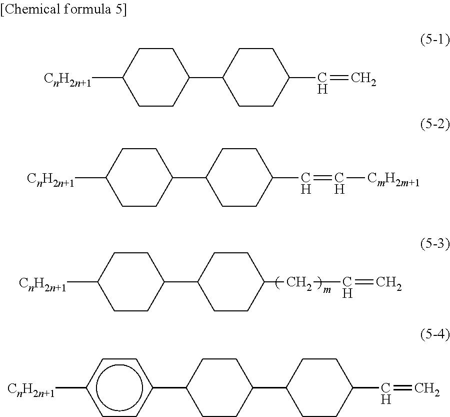
wherein m and n are the same as or different from each other, and each represent an integer of 1 to 6.

7. The liquid crystal display device according to claim 1, which is in a transverse electric field display mode.

8. A method for producing a liquid crystal display device, comprising:
a step of sealing a liquid crystal composition containing a liquid crystal material and at least one type of monomer between a pair of substrates bonded by a sealing member to form a liquid crystal layer; and
a step of irradiating the liquid crystal layer with polarized ultraviolet rays to form an alignment control layer by polymerization of the at least one type of monomer at an interface between the pair of substrates and the liquid crystal layer,
the at least one type of monomer containing a first monomer represented by the following Chemical formula (1),
the alignment control layer aligning the liquid crystal material in a direction horizontal to faces of the substrates, 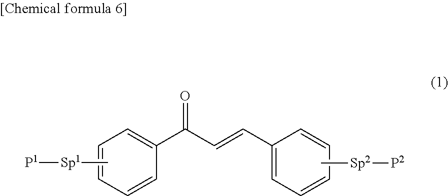
wherein P¹ and P² are the same as or different from each other, and each represent an acryloyloxy group, a methacryloyloxy group, an acryloylamino group, a methacryloylamino group, a vinyl group, or a vinyloxy group, and
Sp¹ and Sp² are the same as or different from each other, and each represent a linear, branched, or cyclic C1-C6 alkylene group, a linear, branched, or cyclic C1-C6 alkyleneoxy group, or a direct bond.

9. The method for producing a liquid crystal display device according to claim 8,
wherein the first monomer is a monomer represented by any one of the following Chemical formulas (2-1) to (2-5):

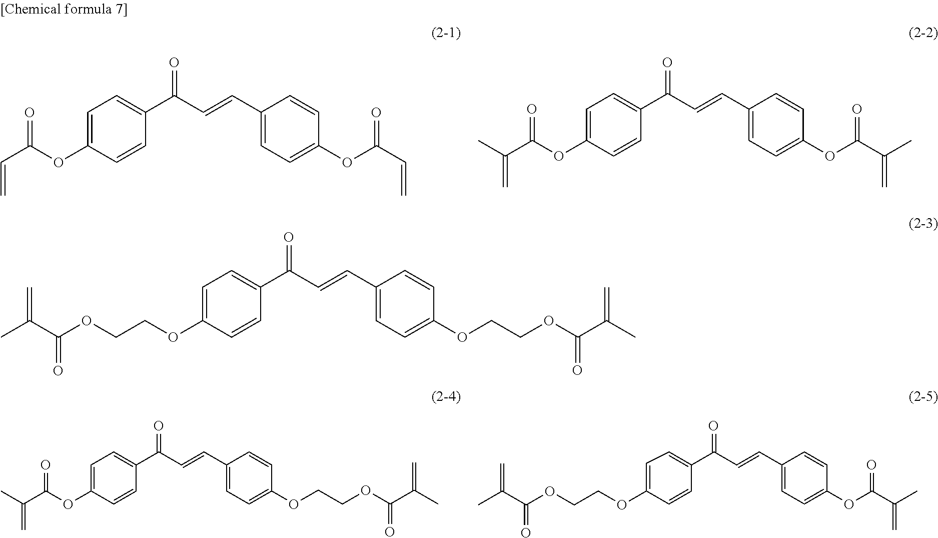

10. The method for producing a liquid crystal display device according to claim 8,
wherein the at least one type of monomer contains a second monomer represented by the following Chemical formula (3): 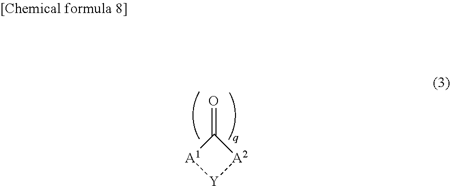
wherein A¹ and A² are the same as or different from each other, and each represent a benzene ring, a biphenyl ring, a linear or branched C1-C12 alkyl group, or a linear or branched C1-C12 alkenyl group,
either one of A₁ and A₂ is a benzene ring or a biphenyl ring,
at least one selected from A₁ and A₂ contains an -Sp³-P³ group,
a hydrogen atom in each of A¹ and A² may be replaced by an -Sp³-P³ group, a halogen atom, a —CN group, an —NO₂ group, an —NCO group, an —NCS group, an —OCN group, an —SCN group, an —SF₅ group, a linear or branched C1-C12 alkyl group, a linear or branched C1-C12 alkenyl group, or a linear or branched C1-C12 aralkyl group,
two adjacent hydrogen atoms in each of A¹ and A² may each be replaced by a linear or branched C1-C12 alkylene group, a linear or branched C1-C12 alkenylene group, or a linear or branched C1-C12 aralkyl group to form a cyclic structure,
a hydrogen atom of an alkyl group, an alkenyl group, an alkylene group, an alkenylene group, or an aralkyl group of each of A¹ and A² may be replaced by an -Sp³-P³ group,
a —CH₂— group of an alkyl group, an alkenyl group, an alkylene group, an alkenylene group or an aralkyl group of each of A¹ and A² may be replaced by an —O— group, an —S— group, an —NH— group, a —CO— group, a —COO— group, an —OCO— group, an —O—COO— group, an —OCH₂— group, a —CH₂O— group, an —SCH₂— group, a —CH₂S— group, an —N(CH₃)— group, an —N(C₂H₅)— group, an —N(C₃H₇)— group, an —N(C₄H₉)— group, a —CF₂₀— group, an —OCF₂— group, a —CF₂S— group, an —SCF₂— group, an —N(CF₃)— group, a —CH₂CH₂— group, a —CH₂CF₂— group, a —CF₂CH₂— group, a —CF₂CF₂— group, a —CH═CH— group, a —CF═CF— group, a —C≡C— group, a —CH═CH—COO— group, or an —OCO—CH═CH— group as long as an oxygen atom, a sulfur atom, and a nitrogen atom are not adjacent to one another,
P³ represents a polymerizable group,
Sp³ represents a linear, branched or cyclic C1-C6 alkylene group, or a linear, branched or cyclic C1-C6 alkyleneoxy group, or a direct bond,
q is 1 or 2,
the dotted line part connecting A¹ and Y, and the dotted line part connecting A² and Y indicate that a bond via Y may exist between A¹ and A², and
Y represents a —CH₂— group, a —CH₂CH₂— group, a —CH═CH— group, an —O— group, an —S— group, an —NH— group, an —N(CH₃)— group, an —N(C₂H₅)— group, an —N(C₃H₇)— group, an —N(C₄H₉)— group, an —OCH₂— group, a —CH₂O— group, an —SCH₂— group, a —CH₂S— group, or a direct bond.

11. The method for producing a liquid crystal display device according to claim 8,
wherein the at least one type of monomer contains a third monomer represented by the following Chemical formula (4): 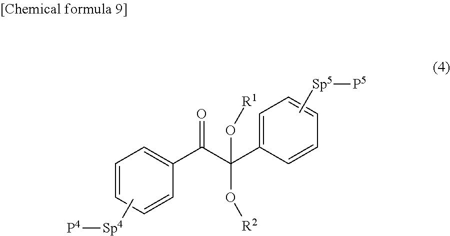
wherein, R¹ and R² are the same as or different from each other, and each represent a linear or branched C1-C4 alkyl group, or a linear or branched C1-C4 alkenyl group,
P⁴ and P⁵ are the same as or different from each other, and each represent an acryloyloxy group, a methacryloyloxy group, an acryloylamino group, a methacryloylamino group, a vinyl group, or a vinyloxy group, and
Sp⁴ and Sp⁵ are the same as or different from each other, and each represent a linear, branched, or cyclic C1-C6 alkylene group, a linear, branched, or cyclic C1-C6 alkyleneoxy group, a linear, branched, or cyclic C1-C6 alkylenecarbonyloxy group, or a direct bond.

12. The method for producing a liquid crystal display device according to claim 8,
wherein in the step of forming an alignment control layer, polarized ultraviolet rays are applied while the liquid crystal layer is heated at a temperature of a nematic phase-isotropic phase transition point of the liquid crystal material or higher and 140° C. or lower.
